(19) United States
(12) Patent Application Publication
(10) Pub. No.: US 2022/0192189 A1
(43) Pub. Date: Jun. 23, 2022

(54) HIGH SPREADING ULV FORMULATIONS FOR FUNGICIDES

(71) Applicant: Bayer Aktiengesellschaft, Leverkusen (DE)

(72) Inventors: Malcolm FAERS, Düsseldorf (DE); Emilia HILZ, Haan (DE); Sybille LAMPRECHT, Leverkusen (DE)

(73) Assignee: Bayer Aktiengesellschaft, Leverkusen (DE)

(21) Appl. No.: 17/595,081

(22) PCT Filed: May 8, 2020
(86) PCT No.: PCT/EP2020/062910

§ 371 Date: Nov. 8, 2021

(30) Foreign Application Priority Data
May 8, 2019 (EP) 19173402.9
May 8, 2019 (EP) 19173403.7
May 8, 2019 (EP) 19173404.5

(51) Int. Cl. A01N 25/30; A01N 25/06; A01N 43/56

(52) U.S. Cl. CPC A01N 25/30; A01N 43/56; A01N 25/06

(57) ABSTRACT

The present invention relates to agrochemical compositions: their use for foliar application; their use at low spray volumes; their use by unmanned aerial systems (UAS), unmanned guided vehicles (UGV), and tractor mounted boom sprayers fitted with conventional nozzles but also pulse width modulation spray nozzles or rotating disc droplet applicators; and their application for controlling agricultural pests, weeds or diseases, in particular on waxy leaves.

The present invention relates to agrochemical compositions: their use for foliar application; their use at low spray volumes; their use by unmanned aerial systems (UAS), unmanned guided vehicles (UGV), and tractor mounted boom sprayers fitted with conventional nozzles but also pulse width modulation spray nozzles or rotating disc droplet applicators; and their application for controlling agricultural pests, weeds or diseases, in particular on waxy leaves.

Modern agriculture faces many challenges in producing sufficient food in a safe and sustainable way. There is therefore a need to utilise crop protection products to enhance the safety, quality and yield while minimising the impact to the environment and agricultural land. Many crop protection products, whether chemical or biological, are normally applied at relatively high spray volumes, for example in selected cases >50 L/ha, and often >150-400 L/ha. A consequence of this is that much energy must be expended to carry the high volume of spray liquid and then apply it to the crop by spray application. This can be performed by large tractors which on account of their weight and also the weight of the spray liquid produce CO₂ from the mechanical work involved and also cause detrimental compaction of the soil, affecting root growth, health and yield of the plants, as well as the energy subsequently expended in remediating these effects.

There is a need for a solution that significantly reduces the high volumes of spray liquid and reduces the weight of the equipment required to apply the product.

In agriculture, low spray volume application technologies including unmanned aerial systems (UAS), unmanned guided vehicles (UGV), and tractor mounted boom sprayers fitted with pulse width modulation spray nozzles or rotating disc droplet applicators are offering farmers solutions to apply products with low spray volumes, typically down to 10 to 20 l/ha or less. These solutions have advantages including for example that they require significantly less water which is important in regions where the supply of water is limited, require less energy to transport and apply the spray liquid, are faster both from quicker filling of the spray tank and faster application, reduce the CO₂ generation from both the reduced volume of spray liquid to transport and from the use of smaller and lighter vehicles, reduced soil compaction damage, and enabling the use of cheaper application systems.

However, Wang et al [Field evaluation of an unmanned aerial vehicle (UAV) sprayer: effect of spray volume on deposition and the control of pests and disease in wheat. Pest Management Science 2019 doi/epdf/10.1002/ps.5321] demonstrated that as the spray volume is decreased from 450 and 225 l/ha to 28.1, 16.8 and 9.0 l/ha, the coverage (% area), number of spray deposits per area, and diameter of the spray deposits as measured on water sensitive paper all decreased (see Table 3 in Wang et al, 2019). In parallel, the biological control efficacy for both wheat aphid control and powdery mildew control decreased at low spray volumes with the greatest decrease observed at 9.0 l/ha, followed by 16.8 l/ha (see FIGS. 6, 7 and 8 in Wang et al, 2019).

There is therefore a need to design formulation systems that overcome the reduction in the coverage and diameter of the spray deposits at low spray volumes even through the number of spray deposits per area is decreasing: as the spray volume decreases, the number of spray droplets per unit area decreases proportionately for the same spray droplet spectra size. This is especially necessary below 25 l/ha, more especially below 17 l/ha, and even more especially at 10 l/ha and below.

The solution is provided by formulations containing a surprising low total amount applied per ha of organosilicone surfactant, below the level normally used and below the level where the organosilicone surfactant is expected to work. Such formulations give increased coverage and increased diameter of spray deposits is comparable to the coverage obtained at normal higher spray volumes. Furthermore, the formulations exemplifying the invention are particularly effective on hard to wet leaf surfaces where more conventional spray volumes have poor retention and coverage.

A particular advantage of the invention stemming from the low total amount of organosilicone-based surfactant compared to the level required at normal higher spray volumes is lower cost of formulations and their ease of production. Further advantages include improved formulation stability and simplified manufacture, less cost of goods as well as less impact on the environment.

The use of organosilicone-based surfactants as tank mix adjuvants has existed for many years, with the recognition that lower spray volumes can be advantageous. R. Gaskin et al [Adjuvant prescriptions to lower water volumes and improve disease control in vineyards, ISAA 2004 proceedings; R. Gaskin et al, New adjuvant technology for pesticide use on wine grapes, New Zealand Plant Protection 55:154-158 (2002); and R. Gaskin et al, Use of a superspreader adjuvant to reduce spray application volumes on avocados, New Zealand Avocado Growers' Association Annual Research Report 2004. 4:8-12] report that organosilicone-based surfactants can be advantageous to reduces spray volumes. However, these refer to relatively high spray volumes, from 100 to 2500 l/ha, and high adjuvant doses, 100 to 800 gl/ha. They do not show or suggest that organosilicone-based surfactants could offer advantages at very low spray volumes, typically down to 10-20 l/ha, or even below, and also at low doses of surfactant, typically 50 g/h and below.

R. Gaskin et al [Effect of surfactant concentration and spray volume on retention of organosilicone sprays on wheat, Proc. 50th N.Z. Plant Protection Conf. 1997: 139-142] concluded that organosilicone-based surfactants are expected to enhance the retention of pesticide sprays on difficult-to-wet arable species over a wide range of spray application volumes. However, the data only covered 37 to 280 l/ha and only referred to retention pesticide sprays but not to plant coverage or size of the spray deposits. Furthermore, there was no mention of ultra-low spray volumes according to the present invention with application volumes down to 10-20 l/ha and in particular embodiments even below this, e.g down to 1-5 l/ha.

All of these refer to tank-mix adjuvants and not to ready to use formulations.

The formulations of the invention, which are most preferably ready to use formulations in contrast to tank mixes, offer the advantage of low spray volumes and thus, low but still effective amounts of active ingredients on the plants by using a higher concentration of organosilicone in the formulations of the invention as indicated herein resulting due to the low spray volume in a lower abundance in the environment after application.

Formulations, also for tank mixes, known in the prior art containing organosilicone-based surfactants are principally designed for much higher spray volumes and generally contain lower concentrations of organosilicone-based surfactants in the spray broth. Nevertheless, due to the high spray volumes used in the prior art, the total amount of organosilicone-based surfactant used and therefore in the environment is higher than according to the present invention.

The concentration of the organosilicone surfactant is an important element of the invention, since suitable spreading occurs when a certain minimum concentration of organosilicone surfactant is achieved, normally 0.05% w/w or w/v (these are equivalent since the density of the organosilicone surfactant is approximately 1.0 g/cm³).

For clarifications sake, as it is understood by a skilled person, spreading means the immediate spreading of a droplet on a surface, i.e. in the context of the present invention the surface of the part of a plant such as a leaf.

Therefore, in a spray volume of 500 l/ha as it is used in the prior art, about 250 g/ha of organosilicone surfactant would be required to achieve suitable spreading. Hence, faced with the task to reduce the spray volume, the skilled person would apply the same concentration of organosilicone surfactant in the formulation. For example, for a spray volume of 10 l/ha about 5 g/ha (about 0.05% in the spray broth) surfactant would be required. However, at such a low volume with such low concentration of organosilicon surfactant sufficient spreading cannot be achieved (see examples).

In this invention, we have surprisingly found that increasing the concentration of organosilicone surfactant as the spray volume decreases can compensate for the loss in coverage (due to insufficient spreading) from the reduction in spray volume. It was surprisingly found that for every reduction of the spray volume by 50%, the concentration of surfactant should roughly be doubled.

Thus, although the absolute concentration of the organosilicone-surfactant is increased compared to formulations known in the art, the relative total amount per ha can be decreased, which is advantageous, both economically and ecologically, while coverage by and efficacy of the formulation according to the invention is improved, maintained or at least kept at an acceptable level when other benefits of the low volume applications are considered, e.g. less costs of formulation due to less cost of goods, smaller vehicles with less working costs, less compacting of soil etc.

A further part of the invention that allows surprising low total amount of organosilicone-based surfactants to be used is the surface texture of the target crop leaves. Bico et al [Wetting of textured surfaces, Colloids and Surfaces A, 206 (2002) 41-46] have established that compared to smooth surfaces, textured surfaces can enhance the wetting for formulation spray dilutions with a contact angles <90° and reduce the wetting for contact angles >90°.

This is also the case for leaf surfaces, in particular textured leaf surfaces, when sprayed in a method according to the invention resulting in low total amounts (per ha) of organosilicone-based surfactants due to the low spray volumes with formulations according to the invention having a high concentration of the organosilicone surfactant. Remarkably high coverage of the leaf surfaces by the spray liquid, even to a level greater than would be normally be expected, could be demonstrated.

Textured leaf surfaces include leaves containing micron-scale wax crystals on the surface such as wheat, barley, rice, rapeseed, soybean (young plants) and cabbage for example, and leaves with surface textures such as lotus plant leaves for example. The surface texture can be determined by scanning electron microscope (SEM) observations and the leaf wettability determined by measuring the contact angle made by a drop of water on the leaf surface.

In summary, the object of the present invention is to provide a formulation which can be applied in ultra-low volumes, i.e. <20 l/ha, while still providing good leaf coverage, uptake and biological efficacy against fungicidal pathogens and at the same time reducing the amounts of additional additives applied per ha, as well as a method of using said formulation at ultra-low volumes (<20 l/ha), and the use of said formulation for application in ultra-low volumes as defined above.

While the application on textured leaves is preferred, surprisingly it was found that also on non-textured leaves the formulations according to the instant invention showed good spreading and coverage as well as other properties compared to classical spray application formulations for 200 l/ha.

In one aspect, the present invention is directed to the use of the compositions according to the invention for foliar application.

If not otherwise indicated, % in this application means percent by weight (% w/w).

It is understood that in case of combinations of various components, the percentages of all components of the formulations always sum up to 100.

Further, if not otherwise indicated, the reference “to volume” for water indicates that water is added to a total volume of a formulation of 1000 ml (1 l).

In the context of the present invention aqueous based agrochemical compositions comprise at least 5% of water and include suspension concentrates, aqueous suspensions, suspo-emulsions or capsule suspensions, preferably suspension concentrates and aqueous suspensions.

Further, it is understood, that the preferred given ranges of the application volumes or application rates as well as of the respective ingredients as given in the instant specification can be freely combined and all combinations are disclosed herein, however, in a more preferred embodiment, the ingredients are preferably present in the ranges of the same degree of preference, and even more preferred the ingredients are present in the most preferred ranges.

In one aspect, the invention refers to a formulation comprising:
a) One or more active ingredients selected from the group of agrochemically applied fungicides,
b) One or more organosilicone based surfactants (preferably a polyalkyleneoxide modified heptamethyltrisiloxane),
c) one or more other formulants, and
d) water to volume,
wherein b) is present in 5 to 250 g/l.

If not otherwise indicated in the present invention the water is usually used to volume the formulation. Preferably, the concentration of water in the formulation according to the invention is at least 50 g/l, more preferred at least 100 g/l, such as at least 200 g/l, at least 400 g/l, at least 500 g/l, at least 600 g/l, at least 700 g/l, and at least 800 g/l.
The formulation is preferably a spray application to be used on crops.

In a preferred embodiment the formulation of the instant invention comprises
a) One or more active ingredients selected from the group of agrochemically applied fungicides,
b) An organosilicone based surfactant (preferably a polyalkyleneoxide modified heptamethyltrisiloxane), and
c1) At least one suitable non-ionic surfactant and/or suitable ionic surfactant,
c2) Optionally, a rheological modifier,
c3) Optionally, a suitable antifoam substance,
c4) Optionally, suitable antifreeze agents,
c5) Optionally, suitable other formulants.
d) Water to volume.
In a preferred embodiment component a) is preferably present in an amount from 5 to 500 g/l, preferably from 10 to 300 g/l, and most preferred from 20 to 200 g/l.
In a preferred embodiment component b) is present in 4 to 250 g/l, preferably from 8 to 120 g/l, and most preferred from 10 to 80 g/l.
In a preferred embodiment the one or more component c1) is present in 4 to 250 g/l, preferably from 8 to 120 g/l, and most preferred from 10 to 80 g/l.
In a preferred embodiment the one or more component c2) is present in 0 to 60 g/l, preferably from 1 to 20 g/l, and most preferred from 2 to 10 g/l.
In a preferred embodiment the one or more component c3) is present in 0 to 30 g/l, preferably from 0.5 to 20 g/l, and most preferred from 1 to 12 g/l.
In a preferred embodiment the one or more component c4) is present in 0 to 200 g/l, preferably from 5 to 150 g/l, and most preferred from 10 to 120 g/l.
In a preferred embodiment the one or more component c5) is present in 0 to 200 g/l, preferably from 0.1 to 120 g/l, and most preferred from 0.5 to 80 g/l.

In one embodiment the formulation comprises the components a) to d) in the following amounts
a) from 5 to 500 g/l, preferably from 10 to 300 g/l, and most preferred from 20 to 200 g/l,
b) from in 4 to 250 g/l, preferably from 8 to 120 g/l, and most preferred from 10 to 80 g/l,
c1) from 4 to 250 g/l, preferably from 8 to 120 g/l, and most preferred from 10 to 80 g/l,
c2) from 0 to 60 g/l, preferably from 1 to 20 g/l, and most preferred from 2 to 10 g/l,
c3) from 0 to 30 g/l, preferably from 0.5 to 20 g/l, and most preferred from 1 to 12 g/l,
c4) from 0 to 200 g/l, preferably from 5 to 150 g/l, and most preferred from 10 to 120 g/l,
c5) from 0 to 200 g/l, preferably from 0.1 to 120 g/l, and most preferred from 0.5 to 80 g/l,
d) water to volume.

In another embodiment the formulation comprises the components a) to d) in the following amounts
b) 5 to 250 g/l
c) 5 to 250 g/l
c1 5 to 120 g/l
c2 1 to 20 g/l
c3 0.1 to 14 g/l
c4 5 to 120 g/l
c5 0.1 to 100 g/l
d) water to volume.

As indicated above, component d) is always added to volume, i.e. to 1 l.

In a further preferred embodiment of the present invention the formulation consists only of the above described ingredients a) to d) in the specified amounts and ranges.

The instant invention further applies to a method of application of the above referenced formulations, wherein the formulation is applied at a spray volume of between 1 and 20 l/ha, preferably 2 and 15 l/ha, more preferably 5 and 15 l/ha.

More preferred, the instant invention applies to a method of application of the above referenced formulations, wherein the formulation is applied at a spray volume of between 1 and 20 l/ha, preferably 2 and 15 l/ha, more preferably 5 and 15 l/ha, and the amount of b) is present in 4 to 250 g/l, preferably from 8 to 120 g/l, and most preferred from 10 to 80 g/l, wherein in a further preferred embodiment a) is present in an amount from 5 to 500 g/l, preferably from 10 to 300 g/l, and most preferred from 20 to 200 g/l.

In an alternative embodiment a) is present from 50 to 100 g/l.

In another embodiment a) is present from 5 to 30 g/l.

In another aspect the instant invention applies to a method of application of the above referenced formulations,

wherein the formulation is applied at a spray volume of between 1 and 20 l/ha, preferably 2 and 15 l/ha, more preferably 5 and 15 l/ha, and

wherein preferably the applied amount of a) to the crop is between 2 and 150 g/ha, preferably between 5 and 120 g/ha, and more preferred between 20 and 100 g/ha.

In one embodiment, the with the above indicated method applied amount of a) to the crop is between 2 and 10 g/ha.

In another embodiment, the with the above indicated method applied amount of a) to the crop is between 40 and 110 g/ha.

In one embodiment in the applications described above, the active ingredient (ai) a) is preferably applied from 2 and 150 g/ha, preferably between 5 and 120 g/ha, and more preferred between 20 and 100 g/ha, while correspondingly the organosilicone-surfactant b) is preferably applied from 10 g/ha to 100 g/ha, more preferably from 20 g/ha to 80 g/ha, and most preferred from 40 g/ha to 60 g/ha.

In particular the formulations of the instant invention are useful for application with a spray volume of between 1 and 20 l/ha, preferably 2 and 15 l/ha, more preferably 5 and 15 l/ha on plants or crops with textured leaf surfaces, preferably on wheat, barley, rice, rapeseed, soybean (young plants) and cabbage.

Further, the instant invention refers to a method of treating crops with textured leaf surfaces, preferably wheat, barley, rice, rapeseed, soybean (young plants) and cabbage, with with a spray volume of between 1 and 20 l/ha, preferably 2 and 15 l/ha, more preferably 5 and 15 l/ha.

In a preferred embodiment the above described applications are done on crops with textured leaf surfaces, preferably on wheat, barley, rice, rapeseed, soybean (young plants) and cabbage.

The corresponding doses of organosilicone surfactant (b) in formulations according to the invention to the applied doses are:

A 2 l/ha liquid formulation delivering
50 g/ha of organosilicone surfactant contains 25 g/l of surfactant (b).
30 g/ha of organosilicone surfactant contains 15 g/l of surfactant (b).
12 g/ha of organosilicone surfactant contains 6 g/l of surfactant (b).
10 g/ha of organosilicone surfactant contains 5 g/l of surfactant (b).

A 1 l/ha liquid formulation delivering:
50 g/ha of organosilicone surfactant contains 50 g/l of surfactant (b),
30 g/ha of organosilicone surfactant contains 30 g/l of surfactant (b),
12 g/ha of organosilicone surfactant contains 12 g/l of surfactant (b),
10 g/ha of organosilicone surfactant contains 10 g/l of surfactant (b).

A 0.5 l/ha liquid formulation delivering:
50 g/ha of organosilicone surfactant contains 100 g/l of surfactant (b),
30 g/ha of organosilicone surfactant contains 60 g/l of surfactant (b),
12 g/ha of organosilicone surfactant contains 24 g/l of surfactant (b),
10 g/ha of organosilicone surfactant contains 20 g/l of surfactant (b).

A 0.2 l/ha liquid formulation delivering:
50 g/ha of organosilicone surfactant contains 250 g/l of surfactant (b),
30 g/ha of organosilicone surfactant contains 150 g/l of surfactant (b),
12 g/ha of organosilicone surfactant contains 60 g/l of surfactant (b),
10 g/ha of organosilicone surfactant contains 50 g/l of surfactant (b).

A 2 kg/ha solid formulation delivering:
50 g/ha of organosilicone surfactant contains 25 g/kg of surfactant (b),
30 g/ha of organosilicone surfactant contains 15 g/kg of surfactant (b),
12 g/ha of organosilicone surfactant contains 6 g/kg of surfactant (b),
10 g/ha of organosilicone surfactant contains 5 g/kg of surfactant (b).

A 1 kg/ha solid formulation delivering:
50 g/ha of organosilicone surfactant contains 50 g/kg of surfactant (b),
30 g/ha of organosilicone surfactant contains 30 g/kg of surfactant (b),
12 g/ha of organosilicone surfactant contains 12 g/kg of surfactant (b),
10 g/ha of organosilicone surfactant contains 10 g/kg of surfactant (b).

A 0.5 kg/ha solid formulation delivering:
50 g/ha of organosilicone surfactant contains 100 g/kg of surfactant (b),
30 g/ha of organosilicone surfactant contains 60 g/kg of surfactant (b),
12 g/ha of organosilicone surfactant contains 24 g/kg of surfactant (b),
10 g/ha of organosilicone surfactant contains 20 g/kg of surfactant (b).

The concentrations of organosilicone surfactant (b) in formulations that are applied at other dose per hectare rates can be calculated in the same way.

In the context of the present invention, suitable formulation types are by definition suspension concentrates, aqueous suspensions, suspo-emulsions or capsule suspensions, emulsion concentrates, water dispersible granules, oil dispersions, emulsifiable concentrates, dispersible concentrates, preferably suspension concentrates, aqueous suspensions, suspo-emulsions and oil dispersions, wherein in the case of non-aqueous formulations or solid formulations the sprayable formulation are obtained by adding water.

Therefore, in one embodiment the formulation is obtained by dilution from a suspension concentrate (SC).

The SC dilution according to the instant invention comprises
a) 0.2 to 200 g/l active ingredient, preferably 1 to 100 g/l
b) 0.5 to 10 g/l organosilicone surfactant, preferably 1 to 5 g/l
c) C1 0.05 to 24, preferably, 0.5 to 12 g/l
   C2 0 to 4 g/l, preferably, 0.1 to 2 g/l
   C3 0 to 4 g/l, preferably, 0.01 to 2 g/l
   C4 0 to 20 g/l, preferably, 0.5 to 24 g/l
   C5 0.001 to 20 g/l, preferably, 0.01 to 5 g/l

Therefore, in one embodiment the formulation is obtained by dilution from a suspo-emulsion (SE).

The SE dilution according to the instant invention comprises
a) 0.2 to 200 g/l active ingredient, preferably 1 to 100 g/l
b) 0.5 to 10 g/l organosilicone surfactant, preferably 1 to 5 g/l
c) C1 0.05 to 24, preferably, 0.5 to 12 g/l
   C2 0 to 4 g/l, preferably, 0.1 to 2 g/l
   C3 0 to 4 g/l, preferably, 0.01 to 2 g/l
   C4 0 to 20 g/l, preferably, 0.5 to 24 g/l
   C5 0.001 to 20 g/l, preferably, 0.01 to 5 g/l

Active Ingredients (a):

The active compounds identified here by their common names are known and are described, for example, in the pesticide handbook (“The Pesticide Manual” 16th Ed., British Crop Protection Council 2012) or can be found on the Internet (e.g. http://www.alanwood.net/pesticides). The classification is based on the current IRAC Mode of Action Classification Scheme at the time of filing of this patent application.

Examples of fungicides (a) according to the invention are:

1) Inhibitors of the ergosterol biosynthesis, for example (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chloro-cyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-yl]methyl}-1H-1,2,4-triazol-5-ylthiocyanate, (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichloro-phenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) mefentrifluconazole, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluoro-phenyl)oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]-phenoxy}phenyl)-N-ethyl-N-methylimidoformamide, (1.068) N′-(2,5-dimethyl-4-{3-[(2,2,2-trifluoro-ethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimido-formamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropyl-cyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimido-formamide, (1.081) ipfentrifluconazole, (1.082) 2-[4-(4-chlorophenoxy)-2-(trifluoromethyl)phenyl]-1-(1H-1,2,4-triazol-1-yl)propan-2-ol, (1.083) 2-[6-(4-bromophenoxy)-2-(trifluoromethyl)-3-pyridyl]-1-(1,2,4-triazol-1-yl)propan-2-ol, (1.084) 2-[6-(4-chlorophenoxy)-2-(trifluoromethyl)-3-pyridyl]-1-(1,2,4-triazol-1-yl)propan-2-ol, (1.085) 3-[2-(1-chlorocyclopropyl)-3-(3-chloro-2-fluoro-phenyl)-2-hydroxy-propyl]imidazole-4-carbonitrile, (1.086) 4-[[6-[rac-(2R)-2-(2,4-difluorophenyl)-1,1-difluoro-2-hydroxy-3-(5-thioxo-4H-1,2,4-triazol-1-yl)propyl]-3-pyridyl]oxy]benzonitrile, (1.087) N-isopropyl-N′-[5-methoxy-2-methyl-4-(2,2,2-trifluoro-1-hydroxy-1-phenylethyl)phenyl]-N-methylimidoformamide, (1.088) N′-{5-bromo-2-methyl-6-[(1-propoxypropan-2-yl)oxy]pyridin-3-yl}-N-ethyl-N-methylimido-formamide, (1.089) hexaconazole, (1.090) penconazole, (1.091) fenbuconazole.

2) Inhibitors of the respiratory chain at complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) inpyrfluxam, (2.029) 3-(difluoromethyl)-1-methyl-N-[(3S)-1,1,3-trimethyl-2,3-dihydro-1H-inden-4-yl]-1H-pyrazole-4-carboxamide, (2.030) fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)-pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) isoflucypram, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide, (2.057) pyrapropoyne, (2.058) N-[rac-(1S,2S)-2-(2,4-dichlorophenyl)cyclobutyl]-2-(trifluoromethyl)-nicotinamide, (2.059) N-[(1S,2S)-2-(2,4-dichlorophenyl)cyclobutyl]-2-(trifluoromethyl)nicotinamide.

3) Inhibitors of the respiratory chain at complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) fenpicoxamid, (3.026) mandestrobin, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid.

4) Inhibitors of the mitosis and cell division, for example (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) pyridachlometyl, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine, (4.026) fluopimomide.

5) Compounds capable to have a multisite action, for example (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper(2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile.

6) Compounds capable to induce a host defence, for example (6.001) acibenzolar-S-methyl, (6.002) isotianil, (6.003) probenazole, (6.004) tiadinil.

7) Inhibitors of the amino acid and/or protein biosynthesis, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline.

8) Inhibitors of the ATP production, for example (8.001) silthiofam.

9) Inhibitors of the cell wall synthesis, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one.

10) Inhibitors of the lipid and membrane synthesis, for example (10.001) propamocarb, (10.002) propamocarb hydrochloride, (10.003) tolclofos-methyl.

11) Inhibitors of the melanin biosynthesis, for example (11.001) tricyclazole, (11.002) tolprocarb.

12) Inhibitors of the nucleic acid synthesis, for example (12.001) benalaxyl, (12.002) benalaxyl-M (kiralaxyl), (12.003) metalaxyl, (12.004) metalaxyl-M (mefenoxam).

13) Inhibitors of the signal transduction, for example (13.001) fludioxonil, (13.002) iprodione, (13.003) procymidone, (13.004) proquinazid, (13.005) quinoxyfen, (13.006) vinclozolin.

14) Compounds capable to act as an uncoupler, for example (14.001) fluazinam, (14.002) meptyldinocap.

15) Further fungicides selected from the group consisting of (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)-phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoro-methyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) ipflufenoquin, (15.042) 2-{2-fluoro-6-[(8-fluoro-2-methylquinolin-3-yl)oxy]phenyl}propan-2-ol, (15.043) fluoxapiprolin, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]-pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one, (15.063) aminopyrifen, (15.064) (N′-[2-chloro-4-(2-fluorophenoxy)-5-methylphenyl]-N-ethyl-N-methylimido-formamide), (15.065) (N′-(2-chloro-5-methyl-4-phenoxyphenyl)-N-ethyl-N-methylimidoformamide), (15.066) (2-{2-[(7,8-difluoro-2-methylquinolin-3-yl)oxy]-6-fluorophenyl}propan-2-ol), (15.067) (5-bromo-1-(5,6-dimethylpyridin-3-yl)-3,3-dimethyl-3,4-dihydroisoquinoline), (15.068) (3-(4,4-difluoro-5,5-dimethyl-4,5-dihydrothieno[2,3-c]pyridin-7-yl)quinoline), (15.069) (1-(4,5-dimethyl-1H-benzimidazol-1-yl)-4,4-difluoro-3,3-dimethyl-3,4-dihydroisoquinoline), (15.070) 8-fluoro-3-(5-fluoro-3,3-dimethyl-3,4-dihydroisoquinolin-1-yl)quinolone, (15.071) 8-fluoro-3-(5-fluoro-3,3,4,4-tetramethyl-3,4-dihydroisoquinolin-1-yl)quinolone, (15.072) 3-(4,4-difluoro-3,3-dimethyl-3,4-dihydroisoquinolin-1-yl)-8-fluoroquinoline, (15.073) (N-methyl-N-phenyl-4-[5-(trifluoromethyl)-1,2,4-oxadiazol-3-yl]benzamide), (15.074) methyl {4-[5-(trifluoromethyl)-1,2,4-oxadiazol-3-yl]phenyl}carbamate, (15.075) (N-{4-[5-(trifluoromethyl)-1,2,4-oxadiazol-3-yl]benzyl}cyclopropanecarboxamide), (15.076) N-methyl-4-(5-(trifluoromethyl)-1,2,4-oxadiazol-3-yl]benzamide, (15.077) N-[(E)-methoxyiminomethyl]-4-[5-(trifluoromethyl)-1,2,4-oxadiazol-3-yl]benzamide, (15.078) N—[(Z)-methoxyiminomethyl]-4-[5-(trifluoromethyl)-1,2,4-oxadiazol-3-yl]benzamide, (15.079) N-[4-[5-(trifluoromethyl)-1,2,4-oxadiazol-3-yl]phenyl]cyclopropanecarboxamide, (15.080) N-(2-fluorophenyl)-4-[5-(trifluoromethyl)-1,2,4-oxadiazol-3-yl]benzamide, (15.081) 2,2-difluoro-N-methyl-2-[4-[5-(trifluoromethyl)-1,2,4-oxadiazol-3-yl]phenyl]acetamide, (15.082) N-allyl-N-[[4-[5-(trifluoromethyl)-1,2,4-oxadiazol-3-yl)phenyl]methyl]acetamide, (15.083) N-[(E)-N-methoxy-C-methyl-carbonimidoyl]-4-(5-(trifluoro-methyl)-1,2,4-oxadiazol-3-yl]benzamide, (15.084) N—[(Z)—N-methoxy-C-methyl-carbonimidoyl]-4-[5-(trifluoromethyl)-1,2,4-oxadiazol-3-yl]benzamide, (15.085) N-allyl-N-[[4-[5-(trifluoromethyl)-1,2,4-oxadiazol-3-yl]phenyl]methyl]propanamide, (15.086) 4,4-dimethyl-1-[[4-[5-(trifluoromethyl)-1,2,4-oxadiazol-3-yl]phenyl]methyl]pyrrolidin-2-one, (15.087) N-methyl-4-[5-(trifluoromethyl)-1,2,4-oxadiazol-3-yl]benzenecarbothioamide, (15.088) 5-methyl-1-[[4-[5-(trifluoromethyl)-1,2,4-oxadiazol-3-yl]phenyl]methyl]pyrrolidin-2-one, (15.089) N-((2,3-difluoro-4-[5-(trifluoromethyl)-1,2,4-oxadiazol-3-yl]phenyl]methyl]-3,3,3-trifluoro-propanamide, (15.090) 1-methoxy-1-methyl-3-[[4-[5-(trifluoro-methyl}-1,2,4-oxadiazol-3-yl]phenyl]methyl]urea, (15.091) 1,1-diethyl-3-[[4-[5-(trifluoromethyl}-1,2,4-oxadiazol-3-yl]phenyl]methyl]urea, (15.092) N-[[4-[5-(trifluoromethyl)-1,2,4-oxadiazol-3-yl]phen-yl]methyl]propanamide, (15.093) N-methoxy-N-[[4-[5-(trifluoromethyl)-1,2,4-oxadiazol-3-yl]phenyl]-methyl]cyclopropanecarboxamide, (15.094) 1-methoxy-3-methyl-1-[[4-[5-(trifluoromethyl)-1,2,4-oxadiazol-3-yl]phenyl]methyl]urea, (15.095) N-methoxy-N-[[4-[5-(trifluoromethyl)-1,2,4-oxadiazol-3-yl]phenyl]methyl)cyclopropanecarboxamide, (15.096) N,2-dimethoxy-N-[[4-[5-(trifluoromethyl}-1,2,4-oxadiazol-3-yl]phenyl]methyl]propanamide, (15.097) N-ethyl-2-methyl-N-[[4-[5-(trifluoromethyl)-1,2,4-oxadiazol-3-yl)phenyl]methyl]propanamide, (15.098) 1-methoxy-3-methyl-1-[[4-[5-(trifluoro-methyl)-1,2,4-oxadiazol-3-yl]phenyl]methyl]urea, (15.099) 1,3-dimethoxy-1-[[4-[5-(trifluoromethyl)-1,2,4-oxadiazol-3-yl]phenyl]methyl]urea, (15.100) 3-ethyl-1-methoxy-1-[[4-[5-(trifluoromethyl)-1,2,4-oxadiazol-3-yl]phenyl]methyl]urea, (15.101) 1-[[4-[5-(trifluoromethyl)-1,2,4-oxadiazol-3-yl]phenyl]-methyl]piperidin-2-one, (15.102) 4,4-dimethyl-2-[[4-[5-(trifluoromethyl)-1,2,4-oxadiazol-3-yl]phenyl]-methyl]isooxazolidin-3-one, (15.103) 5,5-dimethyl-2-[[4-[5-(trifluoromethyl)-1,2,4-oxadiazol-3-yl]phenyl]methyl]isoxazolidin-3-one, (15.104) 3,3-dimethyl-1-[[4-[5-(trifluoromethyl)-1,2,4-oxadiazol-3-yl]phenyl]methyl]piperidin-2-one, (15.105) 1-[[3-fluoro-4-(5-(trifluoromethyl)-1,2,4-oxadiazol-3-yl]-phenyl]methyl]azepan-2-one, (15.106) 4,4-dimethyl-2-[[4-(5-(trifluoromethyl)-1,2,4-oxadiazol-3-yl]-phenyl]methyl]isoxazolidin-3-one, (15.107) 5,5-dimethyl-2-[[4-[5-(trifluoromethyl)-1,2,4-oxadiazol-3-yl]phenyl]methyl]isoxazolidin-3-one, (15.108) ethyl 1-{4-[5-(trifluoromethyl)-1,2,4-oxadiazol-3-yl]benzyl}-1H-pyrazole-4-carboxylate, (15.109) N,N-dimethyl-1-{4-[5-(trifluoromethyl)-1,2,4-oxadiazol-3-yl]benzyl}-1H-1,2,4-triazol-3-amine, (15.110) N-{2,3-difluoro-4-[5-(trifluoromethyl)-1,2,4-oxadiazol-3-yl]benzyl}butanamide, (15.111) N-(1-methylcyclopropyl)-4-[5-(trifluoromethyl)-1,2,4-oxadiazol-3-yl]benzamide, (15.112) N-(2,4-difluorophenyl)-4-[5-(trifluoromethyl)-1,2,4-oxadiazol-3-yl]benzamide, (15.113) 1-(5,6-dimethylpyridin-3-yl)-4,4-difluoro-3,3-dimethyl-3,4-dihydroisoquinoline, (15.114) 1-(6-(difluoromethyl)-5-methyl-pyridin-3-yl)-4,4-difluoro-3,3-dimethyl-3,4-dihydro-isoquinoline, (15.115) 1-(5-(fluoromethyl)-6-methyl-pyridin-3-yl)-4,4-difluoro-3,3-dimethyl-3,4-dihydroisoquinoline, (15.116) 1-(6-(difluoromethyl)-5-methoxy-pyridin-3-yl)-4,4-difluoro-3,3-dimethyl-3,4-dihydroisoquinoline, (15.117) 4-[5-(trifluoromethyl)-1,2,4-oxadiazol-3-yl]phenyl dimethyl-carbamate, (15.118) N-{4-[5-(trifluoromethyl)-1,2,4-oxadiazol-3-yl]phenyl}propanamide, (15.119) 3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.120) 9-fluoro-3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.121) 3-[2-(1-{[3,5-bis(difluoromethyl)-1H-pyrazol-1-yl]acetyl}piperidin-4-yl)-1,3-thiazol-4-yl]-1,5-dihydro-2,4-benzodioxepin-6-yl methanesulfonate, (15.122) 3-[2-(1-{[3,5-bis(difluoromethyl)-1H-pyrazol-1-yl]acetyl}piperidin-4-yl)-1,3-thiazol-4-yl]-9-fluoro-1,5-dihydro-2,4-benzodioxepin-6-yl methanesulfonate, (15.123) 1-(6,7-dimethylpyrazolo[1,5-a]pyridin-3-yl)-4,4-difluoro-3,3-dimethyl-3,4-dihydroisoquinoline, (15.124) 8-fluoro-N-(4,4,4-trifluoro-2-methyl-1-phenylbutan-2-yl)quinoline-3-carboxamide, (15.125) 8-fluoro-N-[(2S)-4,4,4-trifluoro-2-methyl-1-phenylbutan-2-yl]quinoline-3-carboxamide, (15.126) N-(2,4-dimethyl-1-phenylpentan-2-yl)-8-fluoroquinoline-3-carboxamide and (15.127) N-[(2S)-2,4-dimethyl-1-phenylpentan-2-yl]-8-fluoroquinoline-3-carboxamide.

The at least one active ingredient is preferably selected from the group comprising fungicides selected from the group comprising classes as described here above (1) Inhibitors of the respiratory chain at complex, in particular azoles, (2) Inhibitors of the respiratory chain at complex I or II, (3) Inhibitors of the respiratory chain at complex, (4) Inhibitors of the mitosis and cell division, (6) Compounds capable to induce a host defence, (10) Inhibitors of the lipid and membrane synthesis, and (15).

Further preferred, the at least one active ingredient a) is selected from the group comprising trifloxistrobin, prothioconazole, tebuconazole, fluopyram, bixafen, isoflucypram, inpyrfluxam, fluoxapiproline, fluopicolide, isotianil, sprioxamin and propamocarb.

All named fungicides of the classes (1) to (15) as described here above can be present in the form of the free compound or, if their functional groups enable this, an agrochemically active salt thereof.

Furthermore, mesomeric forms as well as stereoisomeres or enantiomeres, where applicable, shall be enclosed, as these modifications are well known to the skilled artisan, as well as polymorphic modifications.

If not otherwise specified, in the present invention solid, agrochemical active compounds a) are to be understood as meaning all substances customary for plant treatment, whose melting point is above 20° C.

In a preferred embodiment only one active ingredient as fungicide is present.

In another embodiment the formulation contains as a) a mixture of two fungicides.

In yet another embodiment the formulation contains as) a mixture of three fungicides.

In an alternative embodiment the formulation contains as a) a fungicide and as mixing partner a further active ingredient selected from the group of insecticides, herbicides and safeners.

Organosilicone Surfactant (b)

Suitable organosilicone surfactants organosilicone ethoxylates, in particular organomodified polysiloxanes/trisiloxane alkoxylates with the following CAS No. 27306-78-1, 67674-67-3, 134180-76-0, e.g., Silwet® L77, Silwet® 408, Silwet® 806, BreakThru® S240, BreakThru® S278;

Preferred are polyalkyleneoxide modified heptamethyltrisiloxane, preferably selected from the group comprising the siloxane groups Poly(oxy-1,2-ethanediyl), .alpha.-methyl-.omega.-[3-[1,3,3,3-tetramethyl-1-[(trimethylsilyl)oxy]disiloxanyl]propoxy] (CAS No (27306-78-1), Poly(oxy-1,2-ethanediyl), .alpha.-[3-[1,3,3,3-tetramethyl-1-[(trimethylsilyl)oxy]disiloxanyl]propyl]-.omega.-hydroxy (Cas No 67674-67-3), and Oxirane, methyl-, polymer with oxirane, mono3-1,3,3,3-tetramethyl-1-(trimethylsilyl)oxydisiloxanylpropyl ether (Cas No 134180-76-0).

Other Formulants (c)

c1 Suitable non-ionic surfactants or dispersing aids c1) are all substances of this type which can customarily be employed in agrochemical agents. Preferably, polyethylene oxide-polypropylene oxide block copolymers, preferably having a molecular weight of more than 6,000 g/mol or a polyethylene oxide content of more than 45%, more preferably having a molecular weight of more than 6,000 g/mol and a polyethylene oxide content of more than 45%, polyethylene glycol ethers of branched or linear alcohols, reaction products of fatty acids or fatty acid alcohols with ethylene oxide and/or propylene oxide, furthermore polyvinyl alcohol, polyoxyalkylenamine derivatives, polyvinylpyrrolidone, copolymers of polyvinyl alcohol and polyvinylpyrrolidone, and copolymers of (meth)acrylic acid and (meth)acrylic acid esters, furthermore branched or linear alkyl ethoxylates and alkylaryl ethoxylates, where polyethylene oxide-sorbitan fatty acid esters may be mentioned by way of example. Out of the examples mentioned above selected classes can be optionally phosphated, sulphonated or sulphated and neutralized with bases.

Possible anionic surfactants c1) are all substances of this type which can customarily be employed in agrochemical agents. Alkali metal, alkaline earth metal and ammonium salts of alkylsulphonic or alkylphospohric acids as well as alkylarylsulphonic or alkylarylphosphoric acids are preferred. A further preferred group of anionic surfactants or dispersing aids are alkali metal, alkaline earth metal and ammonium salts of polystyrenesulphonic acids, salts of polyvinylsulphonic acids, salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid.

c2 A rheological modifier is an additive that when added to the recipe at a concentration that reduces the gravitational separation of the dispersed active ingredient during storage results in a substantial increase in the viscosity at low shear rates. Low shear rates are defined as 0.1 s⁻¹ and below and a substantial increase as greater than ×2 for the purpose of this invention. The viscosity can be measured by a rotational shear rheometer.

Suitable rheological modifiers c4) by way of example are:
Polysaccharides including xanthan gum, guar gum and hydroxyethyl cellulose. Examples are Kelzan®, Rhodopol® G and 23, Satiaxane® CX911 and Natrosol® 250 range.
Clays including montmorillonite, bentonite, sepeolite, attapulgite, laponite, hectorite. Examples are Veegum® R, Van Gel® B, Bentone® CT, HC, EW, Pangel® M100, M200, M300, S, M, W, Attagel® 50, Laponite® RD,
Fumed and precipitated silica, examples are Aerosil® 200, Siponat® 22.

Preferred are xanthan gum, montmorillonite clays, bentonite clays and fumed silica.

c3 Suitable antifoam substances c3) are all substances which can customarily be employed in agrochemical agents for this purpose. Silicone oils, silicone oil preparations are preferred. Examples are Silcolapse® 426 and 432 from Bluestar Silicones, Silfoam® SRE and SC132 from Wacker, SAF-184® fron Silchem, Foam-Clear ArraPro-S® from Basildon Chemical Company Ltd, SAG® 1572 and SAG® 30 from Momentive [Dimethyl siloxanes and silicones, CAS No. 63148-62-9]. Preferred is SAG® 1572.

c4 Suitable antifreeze substances are all substances which can customarily be employed in agrochemical agents for this purpose. Suitable examples are propylene glycol, ethylene glycol, urea and glycerine.

c5 Suitable other formulants c5) are selected from biocides, antifreeze, colourants, pH adjusters, buffers, stabilisers, antioxidants, inert filling materials, humectants, crystal growth inhibitors, micronutrients by way of example are:

Possible preservatives are all substances which can customarily be employed in agrochemical agents for this purpose. Suitable examples for preservatives are preparations containing 5-chloro-2-methyl-4-isothiazolin-3-one [CAS-No. 26172-55-4], 2-methyl-4-isothiazolin-3-one [CAS-No. 2682-20-4] or 1,2-benzisothiazol-3(2H)-one [CAS-No. 2634-33-5]. Examples which may be mentioned are Preventol® D7 (Lanxess), Kathon® CG/ICP (Dow), Acticide® SPX (Thor GmbH) and Proxel® GXL (Arch Chemicals).

Possible colourants are all substances which can customarily be employed in agrochemical agents for this purpose. Titanium dioxide, carbon black, zinc oxide, blue pigments, Brilliant Blue FCF, red pigments and Permanent Red FGR may be mentioned by way of example.

Possible pH adjusters and buffers are all substances which can customarily be employed in agrochemical agents for this purpose. Citric acid, sulfuric acid, hydrochloric acid, sodium hydroxide, sodium hydrogen phosphate (Na₂HPO₄), sodium dihydrogen phosphate (NaH₂PO₄), potassium dihydrogen phosphate (KH₂PO₄), potassium hydrogen phosphate (K₂HPO₄), may be mentioned by way of example.

Suitable stabilisers and antioxidants are all substances which can customarily be employed in agrochemical agents for this purpose. Butylhydroxytoluene [3,5-Di-tert-butyl-4-hydroxytoluol, CAS-No. 128-37-0] is preferred.

These spray liquids are applied by customary methods, i.e., for example, by spraying, pouring or injecting, in particular by spraying, and most particular by spraying by UAV.

The application rate of the formulations according to the invention can be varied within a relatively wide range. It is guided by the particular active agrochemicals and by their amount in the formulations.

With the aid of the formulations according to the invention it is possible to deliver active agrochemical to plants and/or their habitat in a particularly advantageous way.

The present invention is also directed to the use of agrochemical compositions according to the invention for the application of the agrochemical active compounds contained to plants and/or their habitat.

With the formulations of the invention it is possible to treat all plants and plant parts. By plants here are meant all plants and plant populations, such as desirable and unwanted wild plants or crop plants (including naturally occurring crop plants). Crop plants may be plants which can be obtained by conventional breeding and optimization methods or by biotechnological and gene-technological methods or combinations of these methods, including the transgenic plants and including the plant cultivars which can or cannot be protected by varietal property rights. By plant parts are to be meant all above-ground and below-ground parts and organs of the plants, such as shoot, leaf, flower and root, an exemplary listing embracing leaves, needles, stems, trunks, flowers, fruit bodies, fruits and seeds and also roots, tubers and rhizomes. The plant parts also include harvested material and also vegetative and generative propagation material.

What may be emphasized in this context is the particularly advantageous effect of the formulations according to the invention with regard to their use in cereal plants such as, for example, wheat, oats, barley, spelt, triticale and rye, but also in maize, sorghum and millet, rice, sugar cane, soya beans, sunflowers, potatoes, cotton, oilseed rape, canola, tobacco, sugar beet, fodder beet, asparagus, hops and fruit plants (comprising pome fruit such as, for example, apples and pears, stone fruit such as, for example, peaches, nectarines, cherries, plums and apricots, citrus fruits such as, for example, oranges, grapefruits, limes, lemons, kumquats, tangerines and satsumas, nuts such as, for example, pistachios, almonds, walnuts and pecan nuts, tropical fruits such as, for example, mango, papaya, pineapple, dates and bananas, and grapes) and vegetables (comprising leaf vegetables such as, for example, endives, corn salad, Florence fennel, lettuce, cos lettuce, Swiss chard, spinach and chicory for salad use, cabbages such as, for example, cauliflower, broccoli, Chinese leaves, Brassica oleracea (L.) convar. acephala var. sabellica L. (curly kale, feathered cabbage), kohlrabi, Brussels sprouts, red cabbage, white cabbage and Savoy cabbage, fruit vegetables such as, for example, aubergines, cucumbers, capsicums, table pumpkins, tomatoes, courgettes and sweetcorn, root vegetables such as, for example celeriac, wild turnips, carrots, including yellow cultivars, Raphanus sativus var. niger and var. radicula, beetroot, scorzonera and celery, legumes such as, for example, peas and beans, and vegetables from the Allium family such as, for example, leeks and onions.

The treatment of the plants and plant parts in accordance with the invention with the inventive formulations is carried out directly or by action on their environment, habitat or storage area in accordance with the customary treatment methods, for example by dipping, spraying, vaporizing, atomizing, broadcasting or painting on and, in the case of propagation material, especially seeds, additionally by single or multiple coating.

The active agrochemicals comprised develop a better biological activity than when applied in the form of the corresponding conventional formulations.

Leaf Surfaces

In Tables 1a and 1b the contact angle of water on leaf surfaces for textured and non-textured is shown.

TABLE 1a
Plants with textured leaves

| | | Contact angle |
|---|---|---|
| | | of water ° |
| Plant | Species | (adaxial) |
| barley | Hordeum vulgare | 143° |
| | (var. Montoya) | |
| corn, BBCH-11 | Zea mays | 150° |
| corn, BBCH-12 | Zea mays | 149° |
| corn, BBCH-13/14 | Zea mays | 148° |
| soybean, BBCH-12 | Glycine max | 149° |
| soybean, BBCH-13 | Glycine max | 144° |
| rice | Oryza sativa | 180° |
| wheat, BBCH-12 | Triticum aestivum | 148° |
| redroot pigweed | Amaranthus retroflexus | not measured |
| fat-hen | Chenopodium album | 137° |
| purple crabgrass | Digitaria sanguinalis | 144° |

TABLE 1b
Plants with non-textured leaves

| | | Contact angle of water ° |
|---|---|---|
| Plant | Species | (adaxial) |
| apple | Malus domestica | 104° |
| tomato | Solanum lycopersicum | 106° |
| corn, BBCH-15/16 | Zea mays | 108° |
| corn, BBCH-17 | Zea mays | 107° |
| corn, BBCH-18 | Zea mays | 96° |
| corn, BBCH-19 | Zea mays | 87° |
| velvetleaf | Abutilon theophrasti | 103° |

Examples of non-textured crops and plants include tomatoes, peppers, potatoes, carrot, celery, sugar beet, beetroot, spinach, lettuce, beans, peas, clover, apple, pear, peach, apricot, plum, mango, avocado, olive, citrus, orange, lemon, lime, grape, fig, cucumber, melon, water melon, strawberry, raspberry, blueberry, sunflower, pumpkin, soybean (>BBCH XX), corn (>BBCH15), cotton.

Examples of textured crops and plants include garlic, onions, leeks, soybean (<BBCH-XX), oats, wheat, barley, rice, sugarcane, pineapple, banana, linseed, lilies, orchids, corn (<BBCH15), cabbage, brussels sprouts, broccoli, Cauliflower, rye, rapeseed, tulips and peanut.

### FIGURES

FIG. 1 shows scanning electron micrographs of leaf surface textures, wherein the upper picture shows a grapevine leaf surface (untextured) and the lower picture shows a soybean leaf surface (textured)

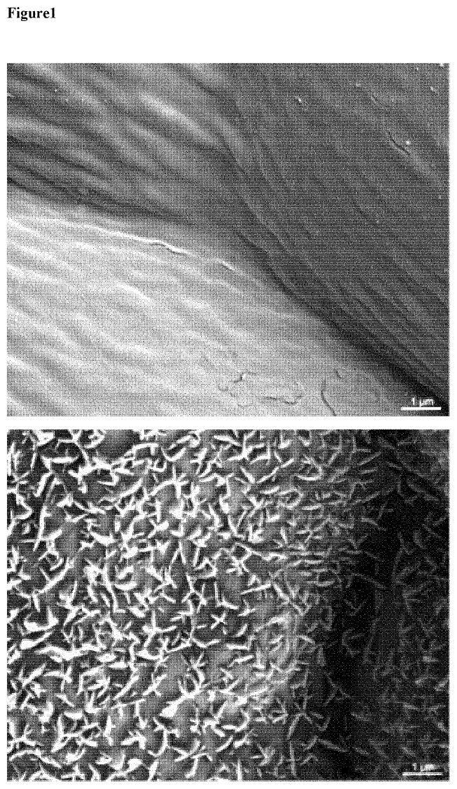

Since soy and corn change leaf properties over their lifetime, according to the present invention the treatment in regard to leaf properties can be adapted, i.e. the formulations according to the invention can be applied in a growth stadium where the leafs are hard to wet.

High Spreading ULV Formulations for Fungicides

The invention is illustrated by the following examples.

### EXAMPLES

Methods

Method 1: SC Preparation

The method of the preparation of suspension concentrate formulations are known in the art and can be produced by known methods familiar to those skilled in the art. A 2% gel of the xanthan (c) in water and the biocides (c) was prepared with low shear stirring. The active ingredient (a), non-ionic and anionic dispersants (c), antifoam (c) and other formulants (c) were mixed with water to form a slurry, first mixed with a high shear rotor-stator mixer (Ultra-Turrax®) to reduce the particle size D(v,0.9) to approximately 50 microns, then passed through one or more bead mills (Eiger® 250 Mini Motormill) to achieve a particles size D(v,0.9) typically 1 to 15 microns. Then the polyalkyleneoxide modified heptamethyltrisiloxane (b) and xanthan gel prepared above were added and mixed in with low shear stirring until homogeneous. Finally, the pH was adjusted to 7.0 (+/−0.2) with acid or base (c).

Method 2: WG Preparation

The method of the preparation of wettable granule formulations are known in the art and can be produced by known methods familiar to those skilled in the art.

To produce a fluid bed granule first a water-based technical concentrate has to be prepared. With low shear stirring the active ingredient, safener (a), surfactants (b), dispersants (c), binder (d), antifoam (e), spreader (f) and filler (g) are mixed in water and finally pre-milled in a high shear rotor-stator mixer (Ultra-Turrax®) to reduce the particle size D(v,0.9) to approximately 50 microns, afterwards passed through one or more bead mills (KDL, Bachofen, Dynomill, Bühler, Drais, Lehmann) to achieve a particles size D(v,0.9) typically 1 to 15 microns.

This water-based technical concentrate is then spray-dried in a fluid-bed granulation process to form the wettable granules (WG).

The particle size is determined according to CIPAC (CIPAC=Collaborative International Pesticides Analytical Council; www.cipac.org) method MT 187. The particle size distribution is determined by means of laser diffraction. A representative amount of sample is dispersed in degassed water at ambient temperature (self-saturation of the sample), treated with ultrasound (usually 60 s) and then measured in a device from the Malvern Mastersizer series (Malvern Panalytical). The scattered light is measured at various angles using a multi-element detector and the associated numerical values are recorded. With the help of the Fraunhofer model, the proportion of certain size classes is calculated from the scatter data and from this a volume-weighted particle size distribution is calculated. Usually the d50 or d90 value=active ingredient particle size (50 or 90% of all volume particles) is given. The average particle size denotes the d50 value.

Method 3:

The method of the preparation of EC formulations are known in the art and can be produced by known methods familiar to those skilled in the art.

The formulations as shown in the Tables below were obtained by dissolving or mixing the active ingredient, safener (a), surfactants (b), spreader (d) in the organic solvent (c) in a standard apparatus.

In some cases the dissolving or mixing was facilitated by raising the temperature slightly (not exceeding 60° C.).

Method 4: Coverage

Greenhouse plants in the development stage as indicated in tables 1a and 1b were used for these experiments. Single leaves were cut just before the spraying experiment, placed into petri dishes and attached by tape at both tips at 0° (horizontally) or at 600 (so that 50% of leaf area can be sprayed). The leaves were carried with caution to avoid damage of the wax surface. These horizontally orientated leaves were either a) placed into a spay chamber where the spray liquid was applied via a hydraulic nozzle or b) a 4 μL drop of spray liquid was pipetted on top without touching the leaf surface.

A small amount of UV dye was added to the spray liquid to visualize the spray deposits under UV light. The concentration of the dye has been chosen such that it does not influence the surface properties of the spray liquid and does not contribute to spreading itself. Tinopal OB as a colloidal suspension was used for all flowable and solid formulation such as WG, SC, OD and SE. Tinopal CBS-X or Blankophor SOL were used for formulations where active ingredient is dissolved such as EC, EW and SL. The Tinopal CBS-X was dissolved in the aqueous phase and the Blankophor SOL dissolved in the oil phase.

After evaporation of the spray liquid, the leaves were placed into a Camag, Reprostar 3 UV chamber where pictures of spray deposits were taken under visual light and under UV light at 366 nm. A Canon EOS 700D digital camera was attached to the UV chamber and used to acquire images the leaves. Pictures taken under visual light were used to subtract the leaf shape from the background. ImageJ software was used to calculate either a) the percentage coverage of the applied spray for sprayed leaves or b) spread area for pipetted drops in mm².

Method 5: Fungicide Greenhouse Tests

Seeds were laid out in “peat soil T” in plastic pots, covered with soil and cultivated in a greenhouse under optimum growth conditions. Two to three weeks after sowing, the test plants were treated at the one- to two-leaf stage. The test fungicide formulations were prepared with different concentrations and sprayed onto the surface of the plants using different water application rates: 200 I/ha as a standard conventional rate and 10 l/ha as an ultra-low-volume (ULV) application rate. The nozzle type used for all applications was TeeJet TP 8003E, used with 0.7-1.5 bar and 500-600 mm height above plant level. Cereal were put in an 45° angle as this reflected best the spray conditions in the field for cereals. The ULV application rate was achieved by using a pulse-width-modulation (PWM)—system that got attached to the nozzle and the track sprayer device at 30 Hz, opening 8%-100% (10 l-200 l).

In a protective treatment the test plants were inoculated 1 day after the spray application with the respective disease and left to stand in the greenhouse for 1 to 2 weeks under optimum growth conditions. Then, the activity of the fungicide formulation was assessed visually.

In curative conditions plants were first inoculated with the disease and treated 2 days later with the fungicide formulations. Visual assessment of the disease was done 5 days after application of formulations.

The practices for inoculation are well known to those skilled in the art.

The following table shows the diseases and crops used in the tests.

| | | | | Abbreviation/ |
|---|---|---|---|---|
| Plant | Crop | | | EPPO |
| species | Variety | Disease | English Name | Code disease |
| Soybean | Merlin | Phakopsora | Soybean rust | PHAKPA |
| | | pachyrhizi | | |
| Wheat | Monopol | Puccinia triticina | Brown rust | PUCCRT |
| Barley | Gaulois | Pyrenophora teres | Net blotch | PYRNTE |
| Barley | Villa | Blumeria graminis | Powdery mildew | ERYSGH |
| Tomato | Rentita | Phytophtora | Late blight | PHYTIN |
| | | infestans | | |

Leaf Surfaces

In Tables 1a and 1b the contact angle of water on leaf surfaces for textured and non-textured is shown.

TABLE 1a
Plants with textured leaves

| | | Contact angle |
|---|---|---|
| | | of water ° |
| Plant | Species | (adaxial) |
| barley | Hordeum vulgare | 143° |
| | (var. Montoya) | |
| corn, BBCH-11 | Zea mays | 150° |
| corn, BBCH-12 | Zea mays | 149° |
| corn, BBCH-13/14 | Zea mays | 148° |
| soybean, BBCH-12 | Glycine max | 149° |
| soybean, BBCH-13 | Glycine max | 144° |
| rice | Oryza sativa | 180° |
| wheat, BBCH-12 | Triticum aestivum | 148° |
| fat-hen | Chenopodium album | 137° |
| purple crabgrass | Digitaria sanguinalis | 144° |

TABLE 1b
Plants with non-textured leaves

| | | Contact angle of water ° |
|---|---|---|
| Plant | Species | (adaxial) |
| apple | Malus domestica | 104° |
| tomato | Solanum lycopersicum | 106° |
| corn, BBCH-15/16 | Zea mays | 108° |
| corn, BBCH-17 | Zea mays | 107° |
| corn, BBCH-18 | Zea mays | 96° |
| corn, BBCH-19 | Zea mays | 87° |
| velvetleaf | Abutilon theophrasti | 103° |
| redroot pigweed | Amaranthus retroflexus | not measured |

Examples of non-textured crops and plants include tomatoes, peppers, potatoes, carrot, celery, sugar beet, beetroot, spinach, lettuce, beans, peas, clover, apple, pear, peach, apricot, plum, mango, avocado, olive, citrus, orange, lemon, lime, grape, fig, cucumber, melon, water melon, strawberry, raspberry, blueberry, sunflower, pumpkin, soybean (≥GS 16 (BBCH 16)), corn (≥GS 15 (BBCH 15), cotton.

Examples of textured crops and plants include garlic, onions, leeks, soybean (≤GS 16 (BBCH 16)), oats, wheat, barley, rice, sugarcane, pineapple, banana, linseed, lilies, orchids, corn (≤GS 15 (BBCH 15)), cabbage, brussels sprouts, broccoli, Cauliflower, rye, rapeseed, tulips and peanut.

Materials

TABLE 2a
Exemplified trade names and CAS-No's of preferred organosilicone
compounds (b)

| Product | Chemical name | Cas No. | Supplier |
|---|---|---|---|
| Silwet ® | 3-(2-methoxyethoxy)propyl- | 27306-78-1 | Momentive |
| L77 | methyl-bis(trimethylsilyloxy) | | |
| | silane | | |
| Silwet ® | 2-[3-[[dimethyl | 67674-67-3 | Momentive |
| 408 | (trimethylsilyloxy)silyl]oxy- | | |
| | methyl-trimethylsilyloxysilyl] | | |
| | propoxy]ethanol | | |
| Silwet ® | 3-[methyl-bis | 134180-76-0 | Momentive |
| 806 | (trimethylsilyloxy)silyl] | | |
| | propan-1-ol; 2-methyloxirane; | | |
| | oxirane | | |
| Break-thru ® | 3-[methyl-bis | 134180-76-0 | Evonik |
| S240 | (trimethylsilyloxy)silyl] | | |
| | propan-1-ol; 2-methyloxirane; | | |
| | oxirane | | |
| Break-thru ® | 3-(2-methoxyethoxy)propyl- | 27306-78-1 | Evonik |
| S278 | methyl-bis(trimethylsilyloxy) | | |
| | silane | | |
| Silwet ® | Polyalkylenoxide Silane | | Momentive |
| HS 312 | | | |
| Silwet ® | Polyalkylenoxide Silane | | Momentive |
| HS 604 | | | |
| BreakThru ® | Siloxanes and Silicones, | 191044-49-2 | Evonik |
| OE 444 | cetyl Me, di-Me | | |
| BreakThru | 3-[methyl-bis | 134180-76-0 | Evonik |
| SD260 | (trimethylsilyloxy)silyl] | | |
| | propan-1-ol; 2-methyloxirane; | | |
| | oxirane | | |
| BreakThru | 3-[methyl-bis | 134180-76-0 | Evonik |
| S301 | (trimethylsilyloxy)silyl] | | |
| | propan-1-ol; 2-methyloxirane; | | |
| | oxirane | | |

TABLE 2b
Exemplified trade names and CAS-No's of preferred compounds (c)

| Product | Chemical name | Cas No. | Supplier |
|---|---|---|---|
| Morwet ® | Naphthalene sulphonate | 9008-63-3 | New XX |
| D425 | formaldehyde condensate | | |
| | Na salt | | |
| Synperonic ® | block-copolymer of | 9003-11-6 | Croda |
| PE/F127 | polyethylene oxide and | | |
| | polypropylene oxide | | |
| Synperonic ® | alcohol ethoxylate | 68131-39-5 | Croda |
| A7 | (C12/C15-EO7) | | |
| Xanthan | Polysaccharide | 11138-66-2 | |
| Proxel ® GXL | 1.2-benzisothiazol- | 2634-33-5 | Arch |
| | 3(2H)-one | | Chemicals |
| Kathon ® | 5-chloro-2-methyl-4- | 26172-55-4 | Dow |
| CG/ICP | isothiazolin-3-one plus | plus | |
| | 2-methyl-4-isothiazolin- | 2682-20-4 | |
| | 3-one | | |
| Propylene glycol | 1,2-Propylene glycol | 57-55-6 | |
| SAG ® 1572 | Dimethyl siloxanes and | 63148-62-9 | Momentive |
| | silicones | | |
| Atlox ® 4913 | methyl methacrylate | 119724-54-8 | Croda |
| | graft copolymer with | | |
| | polyethylene glycol | | |
| ATLAS ® G | Oxirane, methyl-, | 9038-95-3 | Croda |
| 5000 | polymer with oxirane, | | |
| | monobutyl ether | | |
| SILCOLAPSE ® | Polydimethylsiloxanes | 9016-00-6 | BLUESTAR |
| 454 | and silica | | SILICONES |
| RHODOPOL ® | Polysaccharide | 11138-66-2 | Solvay |
| 23 | | | |
| ACTICIDE ® | Mixture of 2-methyl- | 2682-20-4 | Thor GmbH |
| MBS | 4-isothiazolin-3-one | 2634-33-5 | |
| | (MIT) and 1,2- | | |
| | benzisothiazolin-3-one | | |
| | (BIT) in water | | |
| Soprophor ® | Poly(oxy-1,2-ethanediyl),. | 104376-75-2 | Solvay |
| TS54 | alpha.-phenyl-.omega.- | 99734-09-5 | |
| | hydroxy-, styrenated | | |

### Example 1 Isoflucypram 50 SC

TABLE 3
Recipes 1 and 2.

| | | | Recipe 2 |
|---|---|---|---|
| | | Recipe 1 | according to |
| Component (g/l) | | reference | the invention |
| Isoflucypram | (a) | 5.0 | 5.0 |
| Morwet ® D425 | (c) | 1.0 | 1.0 |
| Synperonic ® PE/F127 | (c) | 5.0 | 5.0 |
| Silwet ® 806 | (b) | 0.0 | 50.0 |
| Xanthan | (c) | 3.6 | 3.6 |
| Proxel ® GXL | (c) | 1.5 | 1.5 |
| Kathon ® CG/ICP | (c) | 0.8 | 0.8 |
| Propylene glycol | (c) | 60.0 | 60.0 |
| SAG ® 1572 | (c) | 6.0 | 6.0 |
| Na₂HPO₄ | (c) | 1.5 | 1.5 |
| (Buffer solution pH = 7) | | | |
| NaH₂PO₄ | (c) | 0.8 | 0.8 |
| (Buffer solution pH = 7) | | | |
| Water (add to 1 litre) | (C) | To volume | To volume |
| | | (~921) | (~869) |

The method of preparation used was according to Method 1.

Results

Greenhouse

Efficacy Data

TABLE 4
Biological efficacy on PUCCRT 2 (ISY 50 SC)

| | | | Recipe 1 | Recipe 2 |
|---|---|---|---|---|
| Spray | | | reference | according to |
| volume | Rate of SC | Rate of | Efficacy | the invention |
| l/ha | applied l/ha | a.i. g/ha | [%] | Efficacy [%] |
| 200 | 0.5 | 25 | 90 | 100 |
| 200 | 0.1 | 5 | 20 | 80 |
| 200 | 0.05 | 2.5 | 10 | 30 |
| 10 | 0.5 | 25 | 40 | 95 |
| 10 | 0.1 | 5 | 30 | 85 |
| 10 | 0.05 | 2.5 | 10 | 60 |

Method 5: wheat, protective 1 day before inoculation, evaluation 10 DAT

The results show that recipe 2 illustrative of the invention shows higher efficacy at 10 l/ha spray volume than 200 l/ha. Furthermore, recipe 2 shows higher efficacy at both 200 l/ha and 10 l/ha spray volumes than the reference recipe 1 without the organosilicone super-spreader.

TABLE 5
Biological efficacy on PYRNTE 2 (ISY 50 SC)

| | | | Recipe 1 | Recipe 2 |
|---|---|---|---|---|
| Spray | | | reference | according to |
| volume | Rate of SC | Rate of | Efficacy | the invention |
| l/ha | applied l/ha | a.i. g/ha | [%] | Efficacy [%] |
| 200 | 0.5 | 25 | 97 | 100 |
| 200 | 0.1 | 5 | 43 | 100 |
| 200 | 0.05 | 2.5 | 29 | 71 |
| 200 | 0.02 | 1 | 14 | 86 |
| 10 | 0.5 | 25 | 93 | 100 |
| 10 | 0.1 | 5 | 71 | 99 |
| 10 | 0.05 | 2.5 | 71 | 97 |
| 10 | 0.02 | 1 | 79 | 86 |

Method 5: barley, protective 1 day before inoculation, evaluation 10 DAT

The results show that recipe 2 illustrative of the invention shows higher efficacy at 10 l/ha spray volume than 200 l/ha. Furthermore, recipe 2 shows higher efficacy at both 200 l/ha and 10 l/ha spray volumes than the reference recipe 1 without the organosilicone super-spreader.

### Example 3 Isoflucypram 50 SC

TABLE 8
Recipes 5 and 6.

| | | Recipe 5 | Recipe 6 according |
|---|---|---|---|
| Component (g/l) | | reference | to the invention |
| Isoflucypram | (a) | 50.0 | 50.0 |
| Morwet ® D425 | (c) | 10.0 | 5.0 |
| Soprophor ® FLK | (c) | 20.0 | 10.0 |
| Synperonic ® PE/F127 | (c) | 10.0 | 5.0 |
| Silwet ® 806 | (b) | 0.0 | 60.0 |
| Xanthan | (c) | 3.0 | 3.0 |
| Proxel ® GXL | (c) | 1.5 | 1.5 |
| Kathon ® CG/ICP | (c) | 0.8 | 0.8 |
| Propylene glycol | (c) | 60.0 | 60.0 |
| SAG ® 1572 | (c) | 6.0 | 6.0 |

The method of preparation used was according to Method 1.

Spreading—Pipette Spreading Tests on Leaves

The leaf deposit size was determined according to Method 4 (b) (2 uL).

TABLE 9
Spray dilution droplet size and dose on non-textured
apple leaves and textured soybean and rice leaves.

| | | | | Super- | Super- |
|---|---|---|---|---|---|
| | Deposit | Deposit | Deposit | spreading | spreading |
| | area | area | area | surfactant | surfactant |
| | mm\hat{ }2 | mm\hat{ }2 | mm\hat{ }2 | dose | dose |
| Recipe | apple | soybean | rice | g/ha | % w/v |
| Recipe 5 not | 5.12 | 2.45 | 1.14 | 0 | 0 |
| according to | | | | | |
| the invention - | | | | | |
| 10 l/ha | | | | | |
| Recipe 5 not | 5.50 | 2.84 | 1.79 | 0 | 0 |
| according to | | | | | |
| the invention - | | | | | |
| 200 l/ha | | | | | |
| Recipe 6 | 193.9 | 355.9 | 118.3 | 30 | 0.3 |
| according to | | | | | |
| the invention - | | | | | |
| 10 l/ha | | | | | |
| Recipe 6 | 24.97 | 32.86 | 22.05 | 30 | 0.015 |
| according to | | | | | |
| the invention - | | | | | |
| 200 l/ha | | | | | |

Formulations applied at 0.5 l/ha.

The results show that recipe 6 illustrative of the invention shows significantly greater deposit sizes at 10 L/ha spray volume than at 200 L/ha and also compared to the reference recipe 5.

### Example 4: Fungicide TFS 100 SC

TABLE 11

| | | Recipe 8 |
|---|---|---|
| | Recipe 7 | according to |
| Component (g/l) | reference | the invention |
| Trifloxystrobin (a) | 100.0 | 100.0 |
| Morwet ® D425 (c) | 5.0 | 5.0 |
| Synperonic ® PE/F127 (c) | 12.0 | 12.0 |
| Silwet ® 408 (b) | 0.0 | 50.0 |
| Xanthan (c) | 3.0 | 3.0 |
| Proxel ® GXL (c) | 1.8 | 1.8 |
| Kathon ® CG/ICP (c) | 0.8 | 0.8 |
| Propylene glycol (c) | 80.0 | 80.0 |
| SAG ® 1572 (c) | 6.0 | 6.0 |
| Na₂HPO₄ (Buffer | 0.0 | 1.5 |
| solution pH = 7) | | |
| NaH₂PO₄ (Buffer | 0.0 | 0.8 |
| solution pH = 7) | | |
| Water (add to 1 litre) | To volume (~822) | To volume (~770) |

The method of preparation used was according to Method 1.

Results

Spray Coverage Tests on Leaves

The leaf coverage was determined according to method 4.

TABLE 12
Spray deposit coverage and dose on non-textured leaves.

| | | | Organosilicone |
|---|---|---|---|
| | | | surfactant |
| | Leaf | Organosilicone | dose in spray |
| | coverage % | surfactant dose | liquid |
| Recipe | @ 0° apple | g/ha | % w/v |
| Recipe 7 not | 6.4 | 0 | 0 |
| according to the | | | |
| invention - 10 l/ha | | | |
| Recipe 7 not | 12.6 | 0 | 0 |
| according to the | | | |
| invention - 40 l/ha | | | |
| Recipe 7 not | 18.3 | 0 | 0 |
| according to the | | | |
| invention - 200 l/ha | | | |
| Recipe 7 not | 28.3 | 0 | 0 |
| according to the | | | |
| invention - 500 l/ha | | | |
| Recipe 8 according | 44.5 | 25 | 0.25 |
| to the invention - 10 | | | |
| l/ha | | | |
| Recipe 8 according | 25.4 | 25 | 0.0625 |
| to the invention - 40 | | | |
| l/ha | | | |
| Recipe 8 according | 35.3 | 25 | 0.0125 |
| to the invention - 200 | | | |
| l/ha | | | |
| Recipe 8 according | 56.8 | 25 | 0.0005 |
| to the invention - 500 | | | |
| l/ha | | | |

Formulations applied at 0.5 l/ha.

The results show that on non-textured leaves the coverage is generally higher at higher water application volumes.

TABLE 13
Spray deposit coverage and dose on textured leaves.

| | | | | | Organosilicone |
|---|---|---|---|---|---|
| | | | | | surfactant |
| | Leaf | Leaf | Leaf | Organosilicone | dose in spray |
| | coverage % | coverage % | coverage % | surfactant dose | liquid |
| Recipe | @ 0° soybean | @ 0° barley | @ 0° rice | g/ha | % w/v |
| Recipe 7 not | 3 | 2 | 2 | 0 | 0 |
| according to the | | | | | |
| invention - 10 | | | | | |
| l/ha | | | | | |
| Recipe 7 not | 11.5 | 6 | 3.1 | 0 | 0 |
| according to the | | | | | |
| invention - 40 | | | | | |
| l/ha | | | | | |
| Recipe 7 not | 9.7 | 1.7 | 3.5 | 0 | 0 |
| according to the | | | | | |
| invention - 200 | | | | | |
| l/ha | | | | | |
| Recipe 7 not | 17 | 1.7 | 3.8 | 0 | 0 |
| according to the | | | | | |
| invention - 500 | | | | | |
| l/ha | | | | | |
| Recipe 8 | 29.7 | 23.3 | 15.6 | 50 | 0.25 |
| according to the | | | | | |
| invention - 10 | | | | | |
| l/ha | | | | | |
| Recipe 8 | 23 | 17.6 | 10.4 | 50 | 0.0625 |
| according to the | | | | | |
| invention - 40 | | | | | |
| l/ha | | | | | |
| Recipe 8 | 15.8 | 6.3 | 1.2 | 50 | 0.0125 |
| according to the | | | | | |
| invention - 200 | | | | | |
| l/ha | | | | | |
| Recipe 8 | 22.8 | 4.7 | 4.1 | 50 | 0.0005 |
| according to the | | | | | |
| invention - 500 | | | | | |
| l/ha | | | | | |

Formulations applied at 0.5 l/ha.

The results show that recipe 8 illustrative of the invention shows greater coverage at 10 l/ha spray volume than at 200 l/ha and 500 l/ha, and also compared to the reference recipe 7

### Example 6: PTZ 20 SC

TABLE 16
Recipes 15 and 16.

| | | | Recipe 16 |
|---|---|---|---|
| | | Recipe 15 | according to |
| Component (g/l) | | reference | the invention |
| Prothioconazole | (a) | 20.0 | 20.0 |
| Morwet D425 | (c) | 2.0 | 2.0 |
| Synperonic ® PE/F127 | (c) | 5.0 | 5.0 |
| Silwet ® 806 | (b) | 0.0 | 50.0 |
| Xanthan | (c) | 3.0 | 3.0 |
| Proxel ® GXL | (c) | 1.5 | 1.5 |
| Kathon ® CG/ICP | (c) | 0.8 | 0.8 |
| Propylene glycol | (c) | 60.0 | 60.0 |
| SAG ® 1572 | (c) | 2.0 | 6.0 |
| Na₂HPO₄ (Buffer | (c) | 1.5 | 1.5 |
| solution pH = 7) | | | |
| NaH₂PO₄ (Buffer | (c) | 0.8 | 0.8 |
| solution pH = 7) | | | |
| Water (add to 1 litre) | | To volume | To volume |
| | | (~913) | (~863) |

The method of preparation used was according to Method 1.

Greenhouse

TABLE 17
Biological efficacy on PUCCRT

| | Rate | | | Recipe 16 |
|---|---|---|---|---|
| Spray | of SC | Rate | Recipe 15 | according to |
| volume | applied | of a.i. | reference | the invention |
| l/ha | l/ha | g/ha | Efficacy [%] | Efficacy [%] |
| 200 | 5 | 100 | 78 | 94 |
| 200 | 2.5 | 50 | 33 | 78 |
| 200 | 1.25 | 25 | 22 | 56 |
| 10 | 5 | 100 | 94 | 100 |
| 10 | 2.5 | 50 | 67 | 100 |
| 10 | 1.25 | 25 | 22 | 78 |

Method 5: wheat, 1 day protective, evaluation 9 DAT

The results show that recipe 16 illustrative of the invention shows higher efficacy at 10 l/ha spray volume than 200 l/ha. Furthermore, recipe 16 shows higher efficacy at both 200 l/ha and 10 l/ha spray volumes than the reference recipe 15 without the organosilicone super-spreader.

TABLE 18
Biological efficacy on PUCCRT

| | Rate | | | Recipe 16 |
|---|---|---|---|---|
| Spray | of SC | Rate | Recipe 15 | according to |
| volume | applied | of a.i. | reference | the invention |
| l/ha | l/ha | g/ha | Efficacy [%] | Efficacy [%] |
| 200 | 5 | 100 | 56 | 100 |
| 200 | 2.5 | 50 | 22 | 33 |
| 200 | 1.25 | 25 | 11 | 0 |
| 10 | 5 | 100 | 94 | 100 |
| 10 | 2.5 | 50 | 78 | 94 |
| 10 | 1.25 | 25 | 33 | 94 |

Method 5: wheat, 1 dav protective, evaluation 9 DAT

The results show that recipe 16 illustrative of the invention shows higher efficacy at 10 l/ha spray volume than 200 l/ha. Furthermore, recipe 16 shows higher efficacy at both 200 l/ha and 10 l/ha spray volumes than the reference recipe 15 without the organosilicone super-spreader.

TABLE 19
Biological efficacy on PHAKPA

| | Rate | | | Recipe 16 |
|---|---|---|---|---|
| Spray | of SC | Rate | Recipe 15 | according to |
| volume | applied | of a.i. | reference | the invention |
| l/ha | l/ha | g/ha | Efficacy [%] | Efficacy [%] |
| 200 | 0.5 | 5 | 98 | 99 |
| 200 | 0.1 | 1 | 56 | 44 |
| 200 | 0.05 | 0.5 | 51 | 20 |
| 10 | 0.5 | 5 | 100 | 100 |
| 10 | 0.1 | 1 | 98 | 89 |
| 10 | 0.05 | 0.5 | 32 | 53 |

Method 5: soybean, 1 day preventive, evaluation 7 days after infestation

The results show that recipe 16 illustrative of the invention shows higher efficacy at 10 l/ha spray volume than 200 l/ha.

TABLE 20
Biological efficacy on PHAKPA

| | Rate | | | Recipe 16 |
|---|---|---|---|---|
| Spray | of SC | Rate | Recipe 15 | according to |
| volume | applied | of a.i. | reference | the invention |
| l/ha | l/ha | g/ha | Efficacy [%] | Efficacy [%] |
| 200 | 0.5 | 5 | 98 | 100 |
| 200 | 0.1 | 1 | 94 | 98 |
| 200 | 0.05 | 0.5 | 95 | 98 |
| 200 | 0.01 | 0.1 | 58 | 98 |
| 10 | 0.5 | 5 | 100 | 100 |
| 10 | 0.1 | 1 | 98 | 97 |
| 10 | 0.05 | 0.5 | 89 | 91 |
| 10 | 0.01 | 0.1 | 46 | 72 |

Method: soybean, 2 days curative, evaluation 7 days after infestation

The results show that recipe 16 illustrative of the invention shows higher efficacy at 10 l/ha spray volume than 200 l/ha. Furthermore, recipe 16 shows higher efficacy at both 200 l/ha and 10 l/ha spray volumes than the reference recipe without the organosilicone super-spreader.

TABLE 21
Dose rate of organosilicone super-spreader

| | | | | Recipe 16 | |
|---|---|---|---|---|---|
| | | | | according to | |
| | | | | the invention | |
| | | Recipe 15 reference | | | Super- |
| | Rate | Super- | Super- | Super- | spreader |
| Spray | of SC | spreader | spreader | spreader | dose |
| volume | applied | dose | dose | dose | in spray |
| l/ha | l/ha | g/ha | % w/v | g/ha | liquid % w/v |
| 200 | 0.25 | 0 | 0 | 12.5 | 0.00625 |
| 200 | 0.05 | 0 | 0 | 2.5 | 0.00125 |
| 200 | 0.025 | 0 | 0 | 1.25 | 0.000625 |
| 200 | 0.005 | 0 | 0 | 0.25 | 0.000125 |
| 10 | 0.25 | 0 | 0 | 12.5 | 0.125 |
| 10 | 0.05 | 0 | 0 | 2.5 | 0.025 |
| 10 | 0.025 | 0 | 0 | 1.25 | 0.0125 |
| 10 | 0.005 | 0 | 0 | 0.25 | 0.0025 |

the concentration of organosilicone super-spreader at 10 L/ha spray volume gives higher performance than 200 L/ha.

### Example 7: TBZ 20 SC

TABLE 23
Recipes 17 and 18

| | | | Recipe 18 |
|---|---|---|---|
| | | Recipe 17 | according to |
| Component (g/l) | | reference | the invention |
| Tebuconazole | (a) | 20.0 | 20.0 |
| Morwet D425 | (c) | 2.0 | 2.0 |
| Synperonic ® PE/F127 | (c) | 5.0 | 5.0 |
| Silwet ® 806 | (b) | 0.0 | 60.0 |
| Xanthan | (c) | 3.0 | 3.0 |
| Proxel ® GXL | (c) | 1.5 | 1.5 |
| Kathon ® CG/ICP | (c) | 0.8 | 0.8 |
| Propylene glycol | (c) | 60.0 | 60 |
| SAG ® 1572 | (c) | 2.0 | 2.0 |
| Na₂HPO₄ (Buffer | (c) | 1.5 | 1.5 |
| solution pH = 7) | | | |
| NaH₂PO₄ (Buffer | (c) | 0.8 | 0.8 |
| solution pH = 7) | | | |
| Water (add to 1 litre) | (c) | To volume | To volume |
| | | (~913) | (~853) |

The method of preparation used was according to Method 1.

Greenhouse

TABLE 24
Biological efficacy on PHAKPA

| | Rate | | | Recipe 18 |
|---|---|---|---|---|
| Spray | of SC | Rate | Recipe 17 | according to |
| volume | applied | of a.i. | reference | the invention |
| l/ha | l/ha | g/ha | Efficacy [%] | Efficacy [%] |
| 200 | 0.25 | 5 | 99 | 100 |
| 200 | 0.050 | 1 | 53 | 58 |
| 200 | 0.025 | 0.5 | 25 | 48 |
| 10 | 0.25 | 5 | 100 | 100 |
| 10 | 0.050 | 1 | 86 | 90 |
| 10 | 0.025 | 0.5 | 55 | 79 |

Method: soybean, 1 day protective, evaluation 7 dat

The results show that recipe 18 illustrative of the invention shows higher efficacy at 10 l/ha spray volume than 200 l/ha. Furthermore, recipe 18 shows higher efficacy at both 200 l/ha and 10 l/ha spray volumes than the reference recipe without the organosilicone super-spreader.

TABLE 25
Biological efficacy on PHAKPA

| | Rate | | | Recipe 18 |
|---|---|---|---|---|
| Spray | of SC | Rate | Recipe 17 | according to |
| volume | applied | of a.i. | reference | the invention |
| l/ha | l/ha | g/ha | Efficacy [%] | Efficacy [%] |
| 200 | 250 | 5 | 100 | 100 |
| 200 | 50 | 1 | 62 | 94 |
| 200 | 25 | 0.5 | 35 | 64 |
| 200 | 5 | 0.1 | 17 | 24 |
| 10 | 250 | 5 | 96 | 99 |
| 10 | 50 | 1 | 69 | 94 |
| 10 | 25 | 0.5 | 46 | 85 |
| 10 | 5 | 0.1 | 2 | 14 |

Method 5: soybean, 1 day protective, evaluation 7 dat (days after treatment)

The results show that recipe 18 illustrative of the invention shows higher efficacy at 10 l/ha spray volume than 200 l/ha. Furthermore, recipe 18 shows higher efficacy at both 200 l/ha and 10 l/ha spray volumes than the reference recipe 17 without the organosilicone super-spreader.

### Example 8: Bixafen 20 SC

TABLE 26
Recipes 19 and 20

| | | | Recipe 20 |
|---|---|---|---|
| | | Recipe 19 | according to |
| Component (g/l) | | reference | the invention |
| Bixafen | (a) | 20.0 | 20.0 |
| Morwet D425 | (c) | 2.0 | 2.0 |
| Synperonic ® PE/F127 | (c) | 5.0 | 5.0 |
| Silwet ® 806 | (b) | 0.0 | 50 |
| Xanthan | (c) | 3.0 | 3.0 |
| Proxel ® GXL | (c) | 1.5 | 1.5 |
| Kathon ® CG/ICP | (c) | 0.8 | 0.8 |
| Propylene glycol | (c) | 60.0 | 60.0 |
| SAG ® 1572 | (c) | 6.0 | 6.0 |
| Na2HPO4 (Buffer | (c) | 1.5 | 1.5 |
| solution pH = 7) | | | |
| NaH2PO4 (Buffer | (c) | 0.8 | 0.8 |
| solution pH = 7) | | | |
| Water (add to 1 litre) | | To volume | To volume |
| | | (~913) | (~863) |

The method of preparation used was according to Method 1.

Greenhouse

TABLE 27
Biological efficacy on ERYSGH

| | Rate | | | Recipe 20 |
|---|---|---|---|---|
| Spray | of SC | Rate | Recipe 19 | according to |
| volume | applied | of a.i. | reference | the invention |
| l/ha | l/ha | g/ha | Efficacy [%] | Efficacy [%] |
| 200 | 5 | 100 | 50 | 100 |
| 200 | 2.5 | 50 | 17 | 50 |
| 200 | 1.25 | 25 | 0 | 33 |
| 10 | 5 | 100 | 17 | 67 |
| 10 | 2.5 | 50 | 0 | 67 |
| 10 | 1.25 | 25 | 0 | 33 |

Method 5: barley, 1 day protective, evaluation 7 dat

The results show that recipe 20 illustrative of the invention shows higher efficacy at both 200 l/ha and 10 l/ha spray volumes than the reference recipe 19 without the organosilicone super-spreader.

Table 28
Biological efficacy on PUCCRT

| | | | Recipe 19 | Recipe 20 |
|---|---|---|---|---|
| Spray | | | reference | according to the |
| volume | Rate of SC | Rate of | Efficacy | invention |
| l/ha | applied l/ha | a.i. g/ha | [%] | Efficacy [%] |
| 200 | 5 | 100 | 80 | 100 |
| 200 | 2.5 | 50 | 30 | 90 |
| 200 | 1.25 | 25 | 0 | 60 |
| 200 | 0.5 | 10 | 0 | 30 |
| 10 | 5 | 100 | 50 | 70 |
| 10 | 2.5 | 50 | 30 | 80 |
| 10 | 1.25 | 25 | 20 | 50 |
| 10 | 0.5 | 10 | 0 | 30 |

Method 5: barley, 1 day protective, evaluation 12 dat

The results show that recipe 20 illustrative of the invention shows higher efficacy at both 200 l/ha and 10 l/ha spray volumes than the reference recipe 19 without the organosilicone super-spreader.

TABLE 29
Biological efficacy on PUCCRT

| | | | Recipe 19 | Recipe 20 |
|---|---|---|---|---|
| Spray | | | reference | according to |
| volume | Rate of SC | Rate of | Efficacy | the invention |
| l/ha | applied l/ha | a.i. g/ha | [%] | Efficacy [%] |
| 200 | 5 | 100 | 50 | 95 |
| 200 | 2.5 | 50 | 30 | 95 |
| 200 | 1.25 | 25 | 30 | 50 |
| 10 | 5 | 100 | 50 | 90 |
| 10 | 2.5 | 50 | 50 | 80 |
| 10 | 1.25 | 25 | 40 | 80 |

Method 5: barley, 1 day protective, evaluation 12 dat

The results show that recipe 20 illustrative of the invention shows higher efficacy at 10 l/ha spray volume than 200 l/ha. Furthermore, recipe 20 shows higher efficacy at both 200 l/ha and 10 l/ha spray volumes than the reference recipe 19 without the organosilicone super-spreader.

### Example 9: Fluoxapiprolin 5 SC

TABLE 30
Recipes 21 and 22

| | | | Recipe 22 |
|---|---|---|---|
| | | Recipe 21 | according to |
| Component (g/l) | | reference | the invention |
| Fluoxapiprolin | (a) | 5.0 | 5.0 |
| Morwet D425 | (c) | 1.0 | 1.0 |
| Synperonic ® PE/F127 | (c) | 5.0 | 5.0 |
| Silwet ® 408 | (b) | 0.0 | 50 |
| Xanthan | (c) | 3.6 | 3.6 |
| Proxel ® GXL | (c) | 1.5 | 1.5 |
| Kathon ® CG/ICP | (c) | 0.8 | 0.8 |
| Propylene glycol | (c) | 50.0 | 50.0 |
| SAG ® 1572 | (c) | 4.0 | 4.0 |
| Na₂HPO₄ (Buffer solution | (c) | 0.0 | 1.5 |
| pH = 7) | | | |
| NaH₂PO₄ (Buffer solution | (c) | 0.0 | 0.8 |
| pH = 7) | | | |
| Water (add to 1 litre) | | To volume | To volume |
| | | (~929) | (~877) |

The method of preparation used was according to Method 1.

Greenhouse

TABLE 31
Biological efficacy on PHYTIN

| | Rate of | | Recipe 21 | Recipe 22 |
|---|---|---|---|---|
| Spray | SC | | reference | according to |
| volume | applied | Rate of | Efficacy | the invention |
| l/ha | l/ha | a.i. g/ha | [%] | Efficacy [%] |
| 200 | 0.5 | 2.5 | 83 | 96 |
| 200 | 0.2 | 1 | 59 | 76 |
| 200 | 0.1 | 0.5 | 61 | 76 |
| 10 | 0.5 | 2.5 | 54 | 96 |
| 10 | 0.2 | 1 | 37 | 53 |
| 10 | 0.1 | 0.5 | 24 | 44 |

Method 5: tomato, 1 day preventive, evaluation 7 days after infestation

The results show that recipe 22 illustrative of the invention shows higher efficacy at both 200 l/ha and 10 l/ha spray volumes than the reference recipe 21 without the organosilicone super-spreader.

### Example 10: Fluoxapiprolin 50 SC

TABLE 32
Recipes 23 and 24

| | | | Recipe 24 |
|---|---|---|---|
| | | Recipe 23 | according to |
| Component (g/l) | | reference | the invention |
| Fluoxapiprolin | (a) | 50.0 | 50.0 |
| Morwet D425 | (c) | 10.0 | 10.0 |
| Soprophor ® TS54 | (c) | 20.0 | 20.0 |
| Synperonic ® PE/F127 | (b) | 10.0 | 10.0 |
| Silwet ® 408 | (c) | 0.0 | 60.0 |
| Xanthan | (c) | 3.0 | 3.0 |
| Proxel ® GXL | (c) | 1.5 | 1.5 |
| Kathon ® CG/ICP | (c) | 0.8 | 0.8 |
| Propylene glycol | (c) | 60.0 | 60.0 |
| SAG ® 1572 | (c) | 6.0 | 6.0 |
| Na₂HPO₄ (Buffer solution | (c) | 1.5 | 1.5 |
| pH = 7) | | | |
| NaH₂PO₄ (Buffer solution | (c) | 0.8 | 0.8 |
| pH = 7) | | | |
| Water (add to 1 litre) | | To volume | To volume |
| | | (~896) | (~836) |

The method of preparation used was according to Method 1.

Pipette Spreading Tests on Leaves

The leaf deposit size was determined according to Method 4 (b) with 2 μL deposits.

TABLE 33
Spray dilution droplet size and dose on non-textured apple leaves and
textured soybean and rice leaves.

| | | | | | Super- |
|---|---|---|---|---|---|
| | | | | | spreading |
| | | | | Super- | surfactant |
| | Deposit | Deposit | Deposit | spreading | dose in |
| | area | area | area | surfactant | spray |
| | mm\hat{ }2 | mm\hat{ }2 | mm\hat{ }2 | dose | liquid |
| Recipe | apple | soybean | rice | g/ha | % w/v |
| Recipe 23 not | 3.68 | 2.19 | 1.69 | 0 | 0 |
| according to the | | | | | |
| invention—10 l/ha | | | | | |
| Recipe 23 not | 3.58 | 2.24 | 2.23 | 0 | 0 |
| according to the | | | | | |
| invention—200 l/ha | | | | | |
| Recipe 24 according | 156.7 | 271.2 | 153.9 | 60 | 0.6 |
| to the invention—10 | | | | | |
| l/ha | | | | | |
| Recipe 24 according | 20.70 | 36.97 | 29.11 | 60 | 0.03 |
| to the invention—200 | | | | | |
| l/ha | | | | | |

Formulations applied at 0.5 l/ha.

The results show that recipe 24 illustrative of the invention shows greater deposit sizes at 10 L/ha spray volume than at 200 L/ha and also compared to the reference recipe 23. The effect is observed on both textured and non-textured leaf surfaces.

### Example 11 Inpyrfluxam 25 SC

TABLE 34
Recipes 25 and 26

| | | | Recipe 26 |
|---|---|---|---|
| | | Recipe 25 | according to |
| Component (g/l) | | reference | the invention |
| Inpyrfluxam | (a) | 25.0 | 25.0 |
| Morwet ® D425 | (c) | 5.0 | 5.0 |
| Atlox ® 4913 | (c) | 10.0 | 10.0 |
| Synperonic ® PE/F127 | (c) | 5.0 | 5.0 |
| Silwet ® 806 | (b) | 0.0 | 100.0 |
| Xanthan | (c) | 3.6 | 3.6 |
| Proxel ® GXL | (c) | 1.5 | 1.5 |
| Kathon ® CG/ICP | (c) | 0.8 | 0.8 |
| Propylene glycol | (c) | 60.0 | 60.0 |
| SAG ® 1572 | (c) | 6.0 | 6.0 |
| Na₂HPO₄ (Buffer solution | (c) | 1.5 | 1.5 |
| pH = 7) | | | |
| NaH₂PO₄ (Buffer solution | (c) | 0.8 | 0.8 |
| pH = 7) | | | |
| Water (add to 1 litre) | | To volume | To volume |
| | | (~901) | (~801) |

The method of preparation used was according to Method 1.

Pipette Spreading Tests on Leaves

The leaf deposit size was determined according to Method 4 (b) with 2 μL deposits.

TABLE 35
Spray dilution droplet size and dose on non-textured apple leaves and
textured soybean and rice leaves.

| | | | | Super- | Super- |
|---|---|---|---|---|---|
| | Deposit | Deposit | Deposit | spreading | spreading |
| | area | area | area | surfactant | surfactant |
| | mm\hat{ }2 | mm\hat{ }2 | mm\hat{ }2 | dose | dose |
| Recipe | apple | soybean | rice | g/ha | % w/v |
| Recipe 25 not | 7.28 | 2.27 | 1.75 | 0 | 0 |
| according to the | | | | | |
| invention—10 l/ha | | | | | |
| Recipe 25 not | 4.74 | 3.74 | 2.46 | 0 | 0 |
| according to the | | | | | |
| invention—200 l/ha | | | | | |
| Recipe 25 not | 3.20 | 1.34 | 2.61 | 0 | 0 |
| according to the | | | | | |
| invention—800 l/ha | | | | | |
| Recipe 26 according | 145.1 | 241.7 | 149.7 | 100 | 1.0 |
| to the invention—10 | | | | | |
| l/ha | | | | | |
| Recipe 26 according | 85.3 | 198.4 | 51.1 | 100 | 0.05 |
| to the invention—200 | | | | | |
| l/ha | | | | | |
| Recipe 26 according | 34.8 | 59.7 | 29.1 | 100 | 0.0125 |
| to the invention—800 | | | | | |
| l/ha | | | | | |

Formulations applied at 1 l/ha.

The results show that recipe 26 illustrative of the invention shows larger deposit sizes at 10 l/ha spray volume than at 200 l/ha and 800 l/ha and also compared to the reference recipe 25 at all spray volumes.

### Example 12: Fluopicolide 100 SC

TABLE 36
Recipes 27 and 28.

| | | | Recipe 28 |
|---|---|---|---|
| | | Recipe 27 | according to |
| Component (g/l) | | reference | the invention |
| Fluopicolide | (a) | 100.0 | 100.0 |
| Morwet—® D425 | (c) | 10.0 | 10.0 |
| Soprophor ® FLK | (c) | 20.0 | 20.0 |
| Synperonic ® PE/F127 | (b) | 10.0 | 10.0 |
| Silwet ® 408 | (c) | 0.0 | 40.0 |
| Xanthan | (c) | 3.0 | 3.0 |
| Proxel ® GXL | (c) | 1.5 | 1.5 |
| Kathon ® CG/ICP | (c) | 0.8 | 0.8 |
| Propylene glycol | (c) | 60.0 | 60.0 |
| SAG ® 1572 | (c) | 6.0 | 6.0 |
| Na₂HPO₄ (Buffer solution | (c) | 1.5 | 1.5 |
| pH = 7) | | | |
| NaH₂PO₄ (Buffer solution | (c) | 0.8 | 0.8 |
| pH = 7) | | | |
| Water (add to 1 litre) | | To volume | To volume |
| | | (~846) | (~806) |

The method of preparation used was according to Method 1.

Pipette Spreading Tests on Leaves

The leaf deposit size was determined according to Method 4 (b) with 2 μL deposits.

TABLE 37
Spray dilution droplet size and dose on non-textured apple leaves and
textured soybean and rice leaves.

| | | | | | Super- |
|---|---|---|---|---|---|
| | | | | | spreading |
| | | | | Super- | surfactant |
| | Deposit | Deposit | Deposit | spreading | dose in |
| | area | area | area | surfactant | spray |
| | mm\hat{ }2 | mm\hat{ }2 | mm\hat{ }2 | dose | liquid |
| Recipe | apple | soybean | rice | g/ha | % w/v |
| Recipe 27 not | 5.23 | 2.77 | 2.30 | 0 | 0 |
| according to the | | | | | |
| invention—10 l/ha | | | | | |
| Recipe 27 not | 3.49 | 1.21 | 1.52 | 0 | 0 |
| according to the | | | | | |
| invention—200 l/ha | | | | | |
| Recipe 28 according to | 57.95 | 298.5 | 142.3 | 40 | 0.4 |
| the invention—10 l/ha | | | | | |
| Recipe 28 according to | 29.56 | 64.05 | 22.63 | 40 | 0.02 |
| the invention—200 l/ha | | | | | |

Formulations applied at 1.0 l/ha.

The results show that recipe 28 illustrative of the invention shows significantly greater deposit sizes at 10 L/ha spray volume than at 200 L/ha and also compared to the reference recipe 27. The effect is greater on textured leaf surfaces.

### Example 13: Fluopyram 200 SC

TABLE 39
Recipes 29 and 30

| | | | Recipe 30 |
|---|---|---|---|
| | | Recipe 29 | according to |
| Component (g/l) | | reference | the invention |
| Fluopyram | (a) | 200.0 | 200.0 |
| Morwet ® D425 | (c) | 10.0 | 10.0 |
| Soprophor ® TS54 | (c) | 20.0 | 20.0 |
| Synperonic ® PE/F127 | (b) | 10.0 | 10.0 |
| Silwet ® 408 | (c) | 0.0 | 60.0 |
| Xanthan | (c) | 3.0 | 3.0 |
| Proxel ® GXL | (c) | 1.5 | 1.5 |
| Kathon ® CG/ICP | (c) | 0.8 | 0.8 |
| Propylene glycol | (c) | 60.0 | 60.0 |
| SAG ® 1572 | (c) | 6.0 | 6.0 |
| Na₂HPO₄ (Buffer solution | (c) | 1.5 | 1.5 |
| pH = 7) | | | |
| NaH₂PO₄ (Buffer solution | (c) | 0.8 | 0.8 |
| pH = 7) | | | |
| Water (add to 1 litre) | | To volume | To volume |
| | | (~786) | (~726) |

The method of preparation used was according to Method 1

Pipette Spreading Tests on Leaves

The leaf deposit size was determined according to Method 4 (b) with 2 μL deposits.

TABLE 40
Spray dilution droplet size and dose on non-textured apple leaves and
textured soybean and rice leaves.

| | | | | | Super- |
|---|---|---|---|---|---|
| | | | | | spreading |
| | | | | Super- | surfactant |
| | Deposit | Deposit | Deposit | spreading | dose in |
| | area | area | area | surfactant | spray |
| | mm\hat{ }2 | mm\hat{ }2 | mm\hat{ }2 | dose | liquid |
| Recipe | apple | soybean | rice | g/ha | % w/v |
| Recipe 29 not | 3.96 | 1.52 | 1.64 | 0 | 0 |
| according to the | | | | | |
| invention—10 l/ha | | | | | |
| Recipe 29 not | 3.57 | 1.59 | 1.08 | 0 | 0 |
| according to the | | | | | |
| invention—200 l/ha | | | | | |
| Recipe 30 according to | 157.1 | 266.9 | 134.0 | 30 | 0.3 |
| the invention—10 l/ha | | | | | |
| Recipe 30 according to | 57.28 | 71.25 | 24.51 | 30 | 0.015 |
| the invention—200 l/ha | | | | | |

Formulations applied at 0.5 l/ha.

The results show that recipe 30 illustrative of the invention shows significantly greater deposit sizes at 10 L/ha spray volume than at 200 L/ha and also compared to the reference recipe 29. The effect is greater on textured leaf surfaces.

### Example 15 PHC 625 SL

TABLE 48
Recipes 35 and 36

| | | | Recipe 36 |
|---|---|---|---|
| | | Recipe 35 | according to |
| Component (g/l) | | reference | the invention |
| Propamocarb Hydrochloride | (a) | 869.5 | 869.5 |
| 71.98% concentrate (aqueous) | | | |
| Silwet ® HS312 | (b) | 0.0 | 18.0 |
| Etocas ® 35 | (c) | 14.0 | 14.0 |
| SAG ® 1572 | (c) | 1.0 | 1.0 |
| Water (add to 1 litre) | (c) | To volume | To volume |
| | | (~196) | (~178) |

The method of preparation used was according to Method 1.

Pipette Spreading Tests on Leaves

The leaf deposit size was determined according to coverage method 4.

TABLE 49
Spray dilution droplet size and dose on non-textured leaves.

| | Deposit | | Organosilicone |
|---|---|---|---|
| | area | Organosilicone | surfactant dose |
| | mm\hat{ }2 | surfactant dose | in spray liquid |
| Recipe | apple | g/ha | % w/v |
| Recipe 35 not | 5.6 | 0 | 0 |
| according to the | | | |
| invention—10 l/ha | | | |
| Recipe 35 not | 5.31 | 0 | 0 |
| according to the | | | |
| invention—200 l/ha | | | |
| Recipe 36 according to | 11.4 | 18 | 0.18 |
| the invention—10 l/ha | | | |
| Recipe 36 according to | 9.0 | 18 | 0.009 |
| the invention—200 l/ha | | | |

Formulations applied at 1 l/ha.

The results show on non-textured leaves that the coverage is similar at both water application volumes.

TABLE 50
Spray dilution droplet size and dose on textured leaves.

| | | | | | Organo- |
|---|---|---|---|---|---|
| | | | | Organo- | silicone |
| | Deposit | Deposit | Deposit | silicone | surfactant |
| | area | area | area | surfactant | dose in |
| | mm\hat{ }2 | mm\hat{ }2 | mm\hat{ }2 | dose | spray liquid |
| Recipe | soybean | rice | barley | g/ha | % w/v |
| Recipe 35 not | 3.3 | 2.5 | 4.0 | 0 | 0 |
| according to the | | | | | |
| invention—10 | | | | | |
| l/ha | | | | | |
| Recipe 35 not | 1.8 | 1 | 2.8 | 0 | 0 |
| according to the | | | | | |
| invention—200 | | | | | |
| l/ha | | | | | |
| Recipe 36 | 18.1 | 104 | 37.7 | 18 | 0.18 |
| according to the | | | | | |
| invention—10 | | | | | |
| l/ha | | | | | |
| Recipe 36 | 5.5 | 7.3 | 6.9 | 18 | 0.009 |
| according to the | | | | | |
| invention—200 | | | | | |
| l/ha | | | | | |

Formulations applied at 1 l/ha.

The results show that recipe 36 illustrative of the invention shows greater coverage and larger deposit sizes at 10 L/ha spray volume than at 200 L/ha and also compared to the reference recipe 35.

1: An agrochemical formulation comprising
a) one or more active ingredients selected from the group of agrochemically applied fungicides,
b) one or more organosilicone based surfactants,
c) one or more other formulants, and
d) water to volume,
wherein b) is present in an amount from 5 to 250 g/l.

2: The agrochemical formulation according to claim 1, wherein b) is a polyalkyleneoxide modified heptamethyltrisiloxane.

3: The agrochemical formulation according to claim 1, wherein a) is present in an amount from 5 to 500 g/l, preferably from 10 to 300 g/l, and most preferred from 20 to 200 g/l.

4: The agrochemical formulation according to claim 1, wherein the fungicide is selected from the group consisting of trifloxistrobin, prothioconazole, tebuconazole, fluopyram, bixafen, isoflucypram, inpyrfluxam, fluoxapiproline, fluopicolide, isotianil, sprioxamin and propamocarb.

5: The agrochemical formulation according to claim 1, wherein b) is present in an amount from 4 to 250 g/l, preferably from 8 to 120 g/l, and most preferred from 10 to 80 g/l.

6: The agrochemical formulation according to claim 1, wherein c) is present in an amount from 4 to 250 g/l, preferably from 8 to 120 g/l, and most preferred from 10 to 80 g/l.

7: The agrochemical formulation according to claim 1, wherein component c) comprises at least one non-ionic surfactant and/or ionic surfactant.

8: The agrochemical formulation according to claim 1, wherein component c) comprises at least one non-ionic surfactant and/or ionic surfactant (c1), one rheological modifier (c2), one antifoam substance (c3), and one further formulant (c4).

9: The agrochemical formulation according to claim 8, wherein
c1) is present in an amount from 4 to 250 g/l, preferably from 8 to 120 g/l, and most preferred from 10 to 80 g/l, and
c2) is present in an amount from 0 to 60 g/l, preferably from 1 to 20 g/l, and most preferred from 2 to 10 g/l,
c3) is present in an amount from 0 to 30 g/l, preferably from 0.5 to 20 g/l, and most preferred from 1 to 12 g/l,
c4) is present in an amount from 0 to 200 g/l, preferably from 5 to 150 g/l, and most preferred from 10 to 120 g/l, and
c5) is present in an amount from 0 to 200 g/l, preferably from 0.1 to 120 g/l, and most preferred from 0.5 to 80 g/l,

10: The agrochemical composition according to claim 1, wherein the formulation is applied at a spray volume of between 1 and 20 l/ha, preferably 2 and 15 l/ha, more preferably 5 and 15 l/ha.

11: A method of applying the agrochemical composition according to claim 1 onto crops, wherein the formulation is applied at a spray volume of between 1 and 20 l/ha, preferably between 2 and 15 l/ha, and more preferably between 5 and 15 l/ha.

12: The method according to claim 11, wherein the applied amount of a) to the crop is between 2 and 150 g/ha, preferably between 5 and 120 g/ha, and more preferred between 20 and 100 g/ha.

13: The method according to claim 11, wherein the organosilicone based surfactant b) is preferably applied in an amount from 10 g/ha to 100 g/ha, more preferably from 20 g/ha to 80 g/ha, and most preferred from 40 g/ha to 60 g/ha.

14: The method according to claim 11, wherein the formulation is applied on plants or crops with textured leaf surfaces.

15: A method of controlling harmful fungi, comprising applying the agrochemical formulation according to claim 1, wherein the agrochemical formulation is applied by an unmanned aerial vehicle (UAV), an unmanned guided vehicle (UGV), or a pulse-width-module (PWM).

16: A method of controlling harmful fungi, comprising contacting the harmful fungi, habitats of the harmful fungi, hosts of the harmful fungi, such as plants and seed, soil, areas and environments in which the harmful fungi grow or could grow, but also comprising contacting materials, plants, seeds, soil, surfaces or spaces which are to be protected from attack or infestation by the harmful fungi that are harmful to plants, with an effective amount of the agrochemical formulation according to claim 1, characterized in that the agrochemical formulation is applied by an unmanned aerial vehicle (UAV), an unmanned guided vehicle (UGV), or a pulse-width-module (PWM).
